(19) United States
(12) Patent Application Publication
(10) Pub. No.: US 2009/0187509 A1
(43) Pub. Date: Jul. 23, 2009

(54) Methods of Facilitating the Use and Occupancy of Land

(75) Inventors: John Boden McNamee, New South Wales (AU); John Christopher McNamee, New South Wales (AU)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: LOREBRAY PTY. LIMITED, Dural, New South Wales (AU)

(21) Appl. No.: 12/294,306

(22) PCT Filed: Mar. 21, 2007
(86) PCT No.: PCT/AU07/00347

§ 371 Date: Feb. 27, 2009

(30) Foreign Application Priority Data
Mar. 24, 2006 (AU) 2006901531
Dec. 22, 2006 (AU) 2006907289

(51) Int. Cl. G06Q 40/00; G06Q 10/00; G06Q 30/00; G06Q 50/00

(52) U.S. Cl. 705/80; 705/400; 705/35

(57) ABSTRACT

A method (800), apparatus and system for determining the value of a property is disclosed. The property includes land owned by a first party. The method (800) determines a first value representing value of the property at a first time. The method (800) then determines a second value representing value of the property at a second time, excluding modifications made to the land by a second party to whom the property is being leased during a period between the first time and the second time. The method (800) outputs the second value, wherein the first party retains ownership of the land and is entitled to an amount based on the output second value. The second party retains ownership of the modifications made to the land during the period and is entitled to an amount based on the value of the modifications made to the land during the period.

### TECHNICAL FIELD

The acquisition of land usage rights is essential should a building or other modification of any sort, such as a house or factory, be contemplated on that particular block of land. The present invention relates to methods of providing access for the use of and/or occupancy of land for the purpose of using and/or making modifications thereto.

### BACKGROUND TO THE INVENTION

In order to occupy or otherwise use a structure (e.g., a house and/or other dwelling, a factory, an office and/or other buildings, a driveway, parking facilities, retaining walls, sporting facilities, access facilities etc) or otherwise have use of land upon which the structure is built, an end user (e.g., an individual or other entity) must first gain access to the land.

Typically, the end user will need to purchase the land to obtain the right to access and use the land. In this instance, the end user must raise sufficient funds for the purpose of buying the land upon which the structure is situated, or is to be built. Further, the end user must also raise funds to purchase the structure on the land, or to build a structure on the land.

The need to purchase the land can represent a significant hurdle, for example, to home ownership for many people. The cost of acquiring land in many countries around the world, and in Australia, is increasing at a faster rate than peoples' capacity to pay for the land.

Thus, a need clearly exists for a more efficient method of providing land usage and occupation rights.

### SUMMARY OF THE INVENTION

According to one aspect of the present invention there is provided a method of determining the value of a property, said property including land owned by a first party, said method comprising the steps of:

determining a first value representing value of the property at a first time;

determining a second value representing value of the property at a second time excluding modifications made to the land by a second party to whom said property is being leased during a period between said first time and said second time; and

outputting the second value, wherein said first party retains ownership of the land and is entitled to an amount based on the output second value, and wherein said second party retains ownership of said modifications made to the land during said period and is entitled to an amount based on the value of said modifications made to the land during said period.

According to another aspect of the present invention there is provided a system for determining the value of a property, said property including land owned by a first party, said system comprising:

means for determining a first value representing value of the property at a first time;

means for determining a second value representing value of the property at a second time

means for excluding modifications made to the land by a second party to whom said property is being leased during a period between said first time and said second time; and

means for outputting the second value, wherein said first party retains ownership of the land and is entitled to an amount based on the output second value, and wherein said second party retains ownership of said modifications made to the land during said period and is entitled to an amount based on the value of said modifications made to the land during said period.

According to still another aspect of the present invention there is provided a computer readable medium, having a program recorded thereon, where the program is configured to make a computer execute a procedure to determine the value of a property, said property including land owned by a first party, said program comprising:

code for determining a first value representing value of the property at a first time;

code for determining a second value representing value of the property at a second time

code for excluding modifications made to the land by a second party to whom said property is being leased during a period between said first time and said second time; and

code for outputting the second value, wherein said first party retains ownership of the land and is entitled to an amount based on the output second value, and wherein said second party retains ownership of said modifications made to the land during said period and is entitled to an amount based on the value of said modifications made to the land during said period.

According to still another aspect of the present invention there is provided a method of determining the value of a property, said property including land owned by a first party, said method comprising:

storing a record corresponding to a second party to whom the property is being leased, said record including at least a first value representing value of the property at a first time;

determining a second value representing value of the property at a second time excluding modifications made to the land by said second party in a period between said first time and said second time;

updating the record corresponding to the second party according to the second value; and

outputting the second value, wherein the first party retains ownership of the land and is entitled to an amount based on the output second value and said second party retains ownership of the modifications made to the land during said period and is entitled to an amount based on a value of said modifications made to the land during said period.

According to still another aspect of the present invention there is provided a system for determining the value of a property, said property including land owned by a first party, said system comprising:

storage means for storing a record corresponding to a second party to whom the property is being leased, said record including at least a first value representing value of the property at a first time;

determining means for determining a second value representing value of the property at a second time excluding modifications made to the land by said second party in a period between said first time and said second time;

update means for updating the record corresponding to the second party according to the second value; and

output means for outputting the second value, wherein the first party retains ownership of the land and is entitled to an amount based on the output second value and said second party retains ownership of the modifications made to the land during said period and is entitled to an amount based on a value of said modifications made to the land during said period.

According to still another aspect of the present invention there is provided a computer readable medium, having a program recorded thereon, where the program is configured to make a computer execute a procedure to A method of determining the value of a property, said property including land owned by a first party, said method comprising:

code for storing a record corresponding to a second party to whom the property is being leased, said record including at least a first value representing value of the property at a first time;

code for determining a second value representing value of the property at a second time excluding modifications made to the land by said second party in a period between said first time and said second time;

code for updating the record corresponding to the second party according to the second value; and

code for outputting the second value, wherein the first party retains ownership of the land and is entitled to an amount based on the output second value and said second party retains ownership of the modifications made to the land during said period and is entitled to an amount based on a value of said modifications made to the land during said period.

According to still another aspect of the present invention there is provided a method of determining land value, said method comprising the steps of:

providing land owned by a first party to a second party under an agreement allowing the second party to access and use the land as if the second party owned the land, and allowing the second party to have one or more modifications made to the land;

determining a value of the land excluding any modifications made to the land; and

outputting the value of the land, wherein under the agreement the first party retains ownership of the land and is entitled to the value of the land and the second party retains ownership of the modifications and is entitled to at least a portion of a value of the modifications.

According to still another aspect of the present invention there is provided a method of buying land to which one or more modifications have been made, said method comprising the steps of:

determining a value of the land excluding the modifications made to the land;

outputting said value and giving consideration commensurate with said value to the owner of the land in exchange for the land, the seller retaining ownership of the modifications made to the land;

providing the land to the seller under an agreement allowing the seller to access and use the land as if the seller still owned the land, and allowing the seller to have one or more further modifications made to the land, wherein under the agreement the seller may trade or deal with one or more of the modifications made to the land and is entitled to at least a portion of a value of the modifications.

According to still another aspect of the present invention there is provided a method of determining land value, said method comprising the steps of:

determining a value of the land excluding any modifications made to the land;

outputting the value of the land and lending a buyer an amount commensurate to the value of the land to enable the buyer to purchase the land with the land being used as security for the loan;

providing the buyer, under an agreement, with the land to use and occupy and to have one or more further modifications made to the land,

wherein under the agreement the buyer retains ownership of the modifications made to the land, and is entitled to at least a portion of a value of the modifications on sale of the modifications.

According to still another aspect of the present invention there is provided a method of providing land usage and occupation rights, said method comprising the steps of:

leasing land owned by a first party to a second party under an agreement allowing the second party to access and use the land as if the second party owned the land; and

allowing the second party to have one or more modifications made to the land, wherein upon the modifications being made to the land the second party retains ownership of the modifications.

According to still another aspect of the present invention there is provided a method of buying land to which one or more modifications have been made, said method comprising the steps of:

giving consideration to the owner of the land in exchange for the land with the seller retaining ownership of the modifications made to the land;

providing the land to the seller under an agreement allowing the seller to access and use the land as if the seller still owned the land;

allowing the seller to have one or more further modifications made to the land, wherein the seller may trade or deal with one or more of the modifications and any further modifications.

According to still another aspect of the present invention there is provided an apparatus for land value, wherein land owned by a first party is provided to a second party under an agreement allowing the second party to access and use the land as if the second party owned the land, and the second party is allowed to have one or more modifications made to the land, said apparatus comprising:

means for determining a value of the land excluding any modifications made to the land; and

means for outputting the value of the land, wherein under the agreement the first party retains ownership of the land and is entitled to the value of the land and the second party retains ownership of the modifications and is entitled to at least a portion of a value of the modifications.

According to still another aspect of the present invention there is provided a computer readable medium, having a program recorded thereon, where the program is configured to make a computer execute a procedure to determining land value, wherein land owned by a first party is provided to a second party under an agreement allowing the second party to access and use the land as if the second party owned the land, and allowing the second party to have one or more modifications made to the land, said program comprising:

code for determining a value of the land excluding any modifications made to the land; and

code for outputting the value of the land, wherein under the agreement the first party retains ownership of the land and is entitled to the value of the land and the second party retains ownership of the modifications and is entitled to at least a portion of a value of the modifications.

According to still another aspect of the present invention there is provided a method of making modifications to land, said method comprising the steps of:

leasing land owned by a first party to a second party under an agreement for a period of time, allowing the second party to access and use the land for the period as if the second party owned the land;

allowing the second party to have one or more modifications made to the land during the period; and

making modifications to the land during the period, wherein upon the modifications being made to the land, the first party retains ownership of the land and the second party retains ownership of the modifications made to the land during the period.

### BRIEF DESCRIPTION OF THE DRAWINGS

One or more embodiments of the present invention will now be described, by way of example, with reference to the accompanying drawings, in which:

FIG. 1 is a schematic diagram showing the relationships between the parties in embodiments of the present invention;

FIG. 2 is a schematic block diagram of a general purpose computer upon which arrangements described can be practiced;

FIG. 3 is a flow diagram showing a method of providing land usage and occupation rights;

FIG. 4 is a flow diagram showing a method of buying land;

FIG. 5 is a flow diagram showing a method of determining the value of land at a predetermined time;

FIG. 6 is a flow diagram showing a method of estimating an income stream for land leased in accordance with the method of FIG. 3 or FIG. 4; and

FIG. 7 is a flow diagram showing another method of providing land usage and occupation rights;

FIG. 8 is a flow diagram showing a method of determining the value of a property;

Appendix A shows two tables illustrating an example of the increasing value of a land holding, income based on that land holding and bond obligations over a period of seventy five (75) years;

Appendix B shows two tables illustrating another example of the increasing value of a land holding, income based on that land holding and bond obligations over a period of seventy five (75) years;

Appendix C shows a table illustrating how weighting values are applied to the historical data depending on current economic factors;

Appendix D shows a Pension Benefit Units schedule; and

Appendix E shows an alternative Pension Benefit Units Schedule.

### DETAILED DESCRIPTION OF THE PREFERRED EMBODIMENT

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which form public knowledge through their respective publication and/or use. Such should not be interpreted as a representation by the present inventor(s) or patent applicant that such documents or devices in any way form part of the common general knowledge in the art.

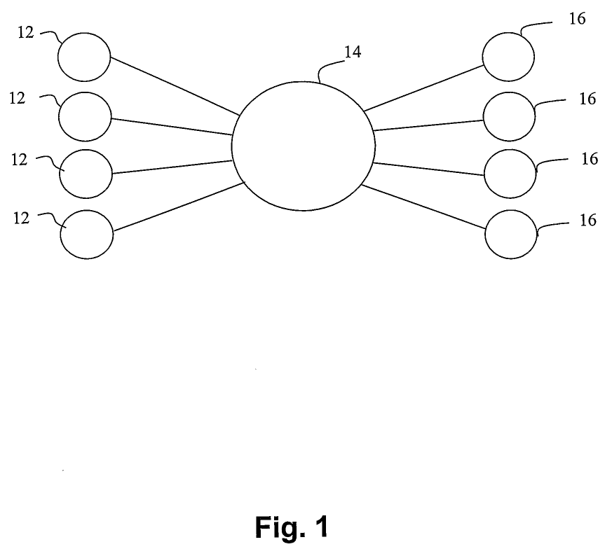

Methods of providing land usage and occupation rights so as to facilitate the making of modifications to the land will be described below with reference to FIGS. 1 to 8. The methods described herein provide that an end user may gain land usage and occupation rights by taking a lease to the land. The end user is relieved of the task of raising enough capital to purchase the land. The end result is that the end user acquires access, use and occupancy of the land, with a lower cost and a lower cash outlay. Thus, the end user can allocate more of their budget to the cost of making modifications to the land. For example, the end user 12 can allocate more of their budget to building their actual dwelling. This means that persons who do not have sufficient capital to purchase a house (or other structure) with land can still “own” their own home (or other structure). As described herein, “owning” or “ownership of” modifications made to a land holding (e.g., building a structure on the land, demolishing and/or modifying an existing structure built on the land, subdividing the land, and/or landscaping an area around a structure built on the land) means that a person, such as the end user 12, has a legal right and/or an economic right and/or a beneficial right in the modifications. This legal, economic and/or beneficial right may be effected by means of any suitable legal instrument including a lease agreement, an assignment or the like. Such a legal instrument essentially transfers ownership of the modifications to the person. Accordingly, the described methods add value and economic wealth to any country implementing the methods and add to the economic wealth of such a country. The described methods also benefit society and advance public interest. Depending on the jurisdiction, the ownership of the modifications made to a land holding may be effected by title deeds to the modifications, which are held separately to the title deeds to the land.

The term “a property” as used herein refers to a land holding and any modifications made to the land (e.g., a structure built on the land, a subdivision made to the land, and/or landscaping made to the land). Referring to FIG. 1, the parties involved in the methods according to embodiments of the invention are shown including end users 12 (one party), a legal structure 14 (another party) and investors 16 (further parties).

The end users 12 are entities and may include individuals, companies, trusts and the like. The end users 12 may occupy, wish to occupy, or otherwise use a “structure” situated upon an area of land (or land holding). The structure may include, for example, a house and/or other dwelling (e.g., dual and/or multiple occupancy such as a block of units), a factory, an office and/or other building, a driveway, parking facilities, retaining walls, sporting facilities (e.g., pool, tennis court, running track etc) and access facilities (e.g., a stair case, an inclinator, a lift).

The end users 12 may also wish to make “modifications” to the land. Such modifications may include, for example, building a structure on the land, demolishing and/or modifying an existing structure built on the land, subdividing the land, and/or landscaping an area around a structure built on the land. Such modifications may also be referred to as “improvements” in some instances

In the described embodiments, the legal structure 14 is a trust. Alternatively, the legal structure 14 may be an incorporated association, a co-operative society or a company limited by guarantee established under Corporations Law. The trust 14 is preferably a long term holding structure that may hold land titles, enter leases, collect rentals and manage delinquencies. The trust 14 may also issue units and/or promises of various classes of assets including guarantees to investors 16. These guarantees, units and/or other classes of assets will hereinafter be referred to as “Pension Benefit Units.” Investors 16 are typically pension funds or superannuation funds in the capital markets and they invest in the Pension Benefit Units. However, the investors 16 may also include individuals, companies, trusts and the like.

The methods described below essentially create a separation between the land and the modifications (or improvements) made to the land. In the methods described below, the trust 14 typically holds legal title (i.e., the Title Deeds) to a land holding and any modifications made to the land including pre-existing modifications and/or modifications that have been made to the land during a non-expired or expired period of an agreement, such as a lease agreement. However, under such a lease agreement or other legal instrument (e.g., an assignment), the methods allow the end user 12 to own (i.e., hold separate legal, economic and/or beneficial rights) the modifications including pre-existing modifications and/or modifications that have been made to the land during a non-expired or expired period of the agreement.

In other embodiments, implemented in various jurisdictions, the trust 14 may hold title, in the form of Title Deeds, to the land with the end user 12 holding separate title, in the form of separate Title Deeds, to the modifications including pre-existing modifications and/or modifications that have been made to the land during a non-expired or expired period of the agreement, depending on the laws of a particular jurisdiction.

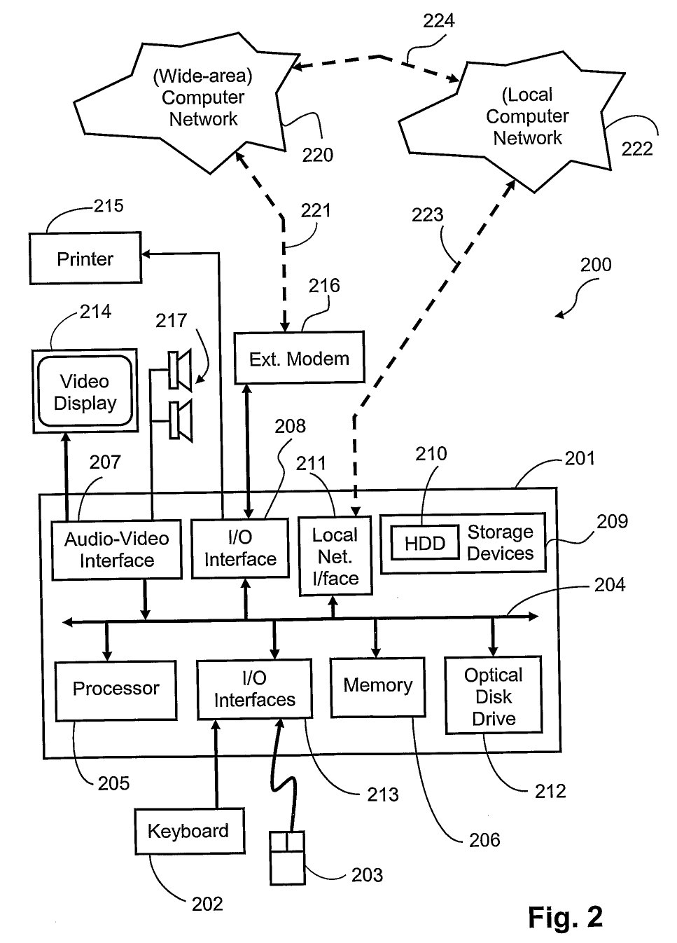

The described methods may be implemented using a computer system 200, such as that shown in FIG. 2 wherein one or more steps of the processes of FIGS. 1 and 3 to 7 may be implemented as software, such as one or more application programs executable within the computer system 200. In particular, one or more of the steps of the described methods may be effected by instructions in the software that are carried out within the computer system 200. The instructions may be formed as one or more code modules, each for performing one or more particular tasks. The software may also be divided into two separate parts, in which a first part and the corresponding code modules performs the described methods and a second part and the corresponding code modules manage a user interface between the first part and the user. The software may be stored in a computer readable medium, including the storage devices described below, for example. The software is loaded into the computer system 200 from the computer readable medium, and is then executed by the computer system 200. A computer readable medium having such software or computer program recorded on it is a computer program product. The use of the computer program product in the computer system 200 preferably effects an advantageous apparatus for implementing the described methods.

As seen in FIG. 2, the computer system 200 is formed by a computer module 201, input devices such as a keyboard 202 and a mouse pointer device 203, and output devices including a printer 215, a display device 214 and loudspeakers 217. An external Modulator-Demodulator (Modem) transceiver device 216 may be used by the computer module 201 for communicating to and from a communications network 220 via a connection 221. The network 220 may be a wide-area network (WAN), such as the Internet or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the network 220.

The computer module 201 typically includes at least one processor unit 205, and a memory unit 206 for example formed from semiconductor random access memory (RAM) and read only memory (ROM). The module 201 also includes an number of input/output (I/O) interfaces including an audio-video interface 207 that couples to the video display 214 and loudspeakers 217, an I/O interface 213 for the keyboard 202 and mouse 203 and optionally a joystick (not illustrated), and an interface 208 for the external modem 216 and printer 215. In some implementations, the modem 216 may be incorporated within the computer module 201, for example within the interface 208. The computer module 201 also has a local network interface 211 which, via a connection 223, permits coupling of the computer system 200 to a local computer network 222, known as a Local Area Network (LAN). As also illustrated, the local network 222 may also couple to the wide network 220 via a connection 224, which would typically include a so-called “firewall” device or similar functionality. The interface 211 may be formed by an Ethernet™ circuit card, a wireless Bluetooth™ or an IEEE 802.21 wireless arrangement.

The interfaces 208 and 213 may afford both serial and parallel connectivity, the former typically being implemented according to the Universal Serial Bus (USB) standards and having corresponding USB connectors (not illustrated). Storage devices 209 are provided and typically include a hard disk drive (HDD) 210. Other devices such as a floppy disk drive and a magnetic tape drive (not illustrated) may also be used. An optical disk drive 212 is typically provided to act as a non-volatile source of data. Portable memory devices, such optical disks (e.g., CD-ROM, DVD), USB-RAM, and floppy disks for example may then be used as appropriate sources of data to the system 200.

The components 205 to 213 of the computer module 201 typically communicate via an interconnected bus 204 and in a manner which results in a conventional mode of operation of the computer system 200 known to those in the relevant art. Examples of computers on which the described arrangements can be practised include IBM-PC's and compatibles, Sun Sparcstations, Apple Mac™ or alike computer systems evolved therefrom.

Typically, the application programs discussed above are resident on the hard disk drive 210 and read and controlled in execution by the processor 205. Intermediate storage of such programs and any data fetched from the networks 220 and 222 may be accomplished using the semiconductor memory 206, possibly in concert with the hard disk drive 210. In some instances, the application programs may be supplied to the user encoded on one or more CD-ROM and read via the corresponding drive 212, or alternatively may be read by the user from the networks 220 or 222. Still further, the software can also be loaded into the computer system 200 from other computer readable media. Computer readable media refers to any storage medium that participates in providing instructions and/or data to the computer system 200 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 201. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces (GUIs) to be rendered or otherwise represented upon the display 214. Through manipulation of the keyboard 202 and the mouse 203, a user of the computer system 200 and the application may manipulate the interface to provide controlling commands and/or input to the applications associated with the GUI(s).

One or more steps of the described methods may alternatively be implemented in dedicated hardware such as one or more integrated circuits performing the functions or sub functions of the described methods. Such dedicated hardware may include graphic processors, digital signal processors, or one or more microprocessors and associated memories.

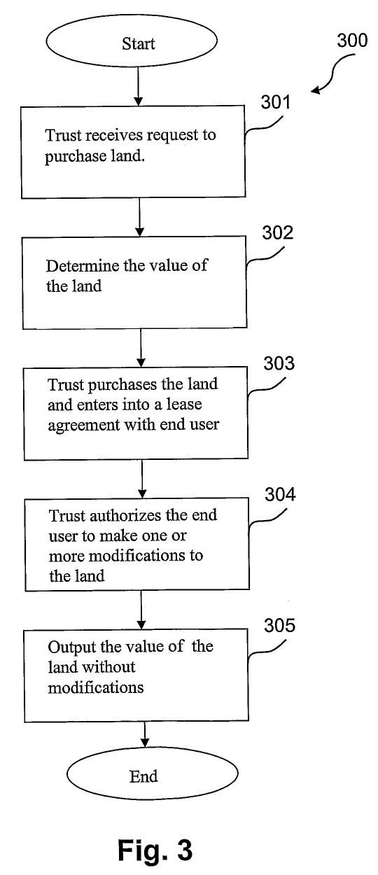

A method 300 of providing land usage and occupation rights so as to facilitate the making of modifications to the land will now be described with reference to FIG. 3. As described above, such modifications may include building a structure on the land, demolishing and/or modifying an existing structure built on the land, subdividing the land, and/or landscaping an area around a structure built on the land. As described above, the structure may include, for example, a house and/or other dwelling (e.g., dual and/or multiple occupancy), a factory, an office and/or other building, a driveway, parking facilities, retaining walls, sporting facilities (e.g., pool, tennis court, running track) and access facilities (e.g., a stair case, an inclinator, a lift). The method 300 determines the value of the land.

The method 300 begins at step 301, where an end user(s) 12 finds an area of land that they do not own but that they wish to use and/or occupy. The land may or may not already have a pre-existing structure, as defined above, built on the land. This pre-existing structure may also be referred to as a “pre-existing modification” made to the land. The end user 12 makes contact with the operator(s) of the trust 14 and requests that the trust 14 purchase the land for the purpose of making the land available to the end user 12. That is, the trust 14 receives a request to purchase the land. If the land has pre-existing modifications on it, then the trust 14 may also be required to purchase the pre-existing modifications. Upon being approached by the end user 12, the trust 14 would typically create (or store) a record, corresponding to the end user 12, in a database configured within the hard disk drive 210, for example.

At the next step 302, the trust 14 determines the value of the land. Typically, at step 302, the land is valued by an independent valuator, for example. In this instance, the value of the land is determined excluding any pre-existing modifications that have been made to the land. However, the value of any such pre-existing modification may also determined. Accordingly, the trust 14 determines the value of the property (i.e., the land and any pre-existing modifications). The value of the pre-existing modifications may be determined as a separate value.

The value of the land (and the value of any pre-existing modifications) determined at step 302 may also be recorded in the database against the record for the end user 12. At the next step 303, the trust 14 enters into an agreement with the end user 12 under which the trust 14 purchases the land and provides the land to the end user 12. The trust 14 may also be required to purchase any pre-existing modifications made to the land. Therefore, the trust 14 holds the title to the land and any pre-existing modifications, in the form of the Title Deeds to the land. In one embodiment, the end user 12 may purchase the pre-existing modifications from the trust 14. In this instance, ownership of the pre-existing modifications may be effected by the agreement entered into between the trust 14 and the end user 12. Alternatively, depending on the jurisdiction, the end user 12 may hold separate title, in the form of separate title deeds to the title deeds for the land, to the pre-existing modifications.

In the described embodiments, the agreement entered into between the trust 14 and the end user 12 at step 303 is a lease agreement. Alternatively, some other suitable occupancy and/or use agreement, or other suitable legal instrument may be used. Under the lease agreement, the land and any pre-existing modifications are provided to the end user 12 by the trust 14 on terms with the effect of allowing land access and use to the end user 12. The effect of these terms is substantially the same as that of actual ownership of the land and any pre-existing modifications by the end user 12. However, as described above, ownership of the pre-existing modifications may be in the form of legal, economic and/or beneficial rights, which are effected by the lease agreement or other suitable legal instrument. The terms of such a lease agreement will be described in detail below.

Then at the next step 304, the trust 14 authorises (or allows) the end user 12 to have one or more modifications or further modifications made to the land. As described above, such modifications may include building a structure on the land, demolishing and/or modifying an existing structure built on the land, subdividing the land, and/or landscaping an area around a structure built on the land. The authorisation by the trust 14 at step 304 is preferably made under the lease agreement. That is, the lease agreement includes terms which authorise the end user 12 to have one or more modifications or further modifications made to the land. The lease agreement also includes terms that enable the end user 12 to have legal, economic and/or beneficial rights in the modifications or further modifications (i.e., to own the modifications or further modifications).

The method 300 concludes at the next step 305, where the value of the land determined at step 302 is output, in order to notify the trust 14, the investors 16 and/or the end user 12, for example, of the value of the land. This output or notification may take any suitable form. For example, the value of the land may be included in a report which is printed on the printer 215 and distributed to each of the trust 14, investors 16 and/or to the end users 12. Such a report on the value may be distributed over the communications network 220, for example, in the form of an email transmission. The value of the land may also be displayed on the display device 214 or transmitted over the communications network 220 for display on other display devices connected to the network 220.

The value of the land may be determined in a similar manner to step 302 (i.e., excluding any pre-existing modifications and/or modifications that have been made to the land during a non-expired or expired period of the agreement) and may be outputted in a similar manner to step 305, on a periodic basis (e.g., every three or six months). The value of any modifications owned by the trust 14 may also be determined on a periodic basis (e.g., every three or six months). The valuation of the land and/or any modifications owned by the trust 14 may be performed in this manner in order to notify investors 16 periodically of the value of the assets owned and controlled by the trust 14. In this instance, the database record corresponding to the end user 12, as created at step 301, is also typically modified (or updated) periodically by inserting any values representing currently determined values of the land. Accordingly, on a periodic basis, the trust 14 may determine the value of the property excluding modifications made to the land by the end user 12 (i.e., a second party to whom the property is being leased) during a non-expired or expired period of the lease agreement.

The value of the land at a predetermined time in the future (e.g., 25 years in the future) may also be determined (or forecast), in a similar manner to step 302. Such a predicted value may be used in investment prediction and, in particular, in land value prediction. Methods of determining (or forecasting) the value of the land at a predetermined time in the future, in accordance with one or more of the described embodiments, will be described below.

The value of the land may also be determined in a similar manner to step 302 in order to determine the value of fees payable by the end user 12 to the trust 14 for leasing the land. In this instance, as described below, the fees may be calculated as a percentage of the value of the land at the date of entering into the lease agreement or at the date that the fee is due. The fees may be based on the higher of the current valuation of the land or the original value of the land compounded with a minimum annual increase. In one embodiment, the fees may also be based on any pre-existing modifications that were made to the land (i.e., prior to the lease agreement being entered into) and that are owned by the trust 14.

In accordance with the method 300, under the agreement, the trust 14 retains ownership of the land and is entitled to the value of the land as determined at step 302 or as periodically determined. The trust 14 may also retain ownership of the pre-existing modifications that were made to the land (i.e., prior to the lease agreement being entered into) and that are owned by the trust 14. Also, under the agreement, the end user 12 retains ownership in all the modifications made to the land be they pre-existing if the end user 12 purchased the pre-existing modifications, or those modifications made to the land during the period (i.e., non-expired or expired) of the lease agreement, together with the rights to use and occupy the land. The end user 12 may trade or deal with the modifications and rights to use and occupy the land during the period of the agreement. For example, the end user 12 may sell their interest in the modifications made to the land for a value determined at the time of selling the modifications. This valuation of the modifications may be made by the end user 12 or an independent valuator. In this instance, the end user 12 is entitled to the proceeds of such a sale subject to payment of any outstanding lease payments, reasonable costs of conducting and managing the sale, and accounting to any mortgagee lender, for example, a bank. A person skilled in the art would appreciate that the proceeds of the sale may be more or less depending on the market at the time of sale. As the trust 14 typically holds the title to the land and the modifications, upon the sale of the modifications, the ownership of the modifications may be transferred to the new owner of these modifications, for example, by transferring the lease agreement to the new owner or by way of any other suitable legal instrument.

### 1. Potential Homer Owners

In one embodiment of the method 300, the end users 12 are potential home owners who wish to own and occupy a home. Such an end user 12 finds an area of land that they do not own but that they wish to occupy, as at step 301. The trust 14 may determine the value of the land as described above with reference to step 302. The end user 12 makes contact with the operator of the trust 14 and requests that the trust 14 purchase the land (and any pre-existing modifications made to the land) for the purpose of leasing the land to the end user 12, again, as at step 301. The trust 14 purchases the land and enters into a lease agreement with the end user 12, as at step 303. If the land has pre-existing modifications on it, then the trust 14 may also be required to purchase the pre-existing modifications. Such pre-existing modifications may also be leased to the end user 12 under the lease agreement. The agreement will be described in detail below. The trust 14 authorises (or allows) the end user 12 to make one or more modifications or further modifications made to the land, as at step 304. Again, the authorisation by the trust 14 at step 304 is preferably made under the lease agreement, where the lease agreement includes terms which authorise the end user 12 to have one or more modifications or further modifications made to the land. These modifications or further modifications may be, for example, either by way of building a new home or modifying a home pre-existing on the land. The value of the land determined as at step 302 may be output to the trust 14, to the investors 16 and/or to the end user 12, as at step 305. The value of any modifications owned by the trust 14 may also be output. Under the lease agreement, the end user 12 retains ownership of any modifications made to the land be they pre-existing if the end user 12 purchased the pre-existing modifications, or those modifications made to the land during the period (i.e., non-expired or expired) of the lease agreement, together with the rights to use and occupy the land.

As described above, the initial outlay for the end user 12 (i.e., potential home owner) in taking a lease to the land is far less than the cost of purchasing the land. By taking a lease to the land, the end user 12 is relieved of the task of raising enough capital to purchase the land. The end result is the same in that the end user 12 is still acquiring access, use and occupancy of the land, with a lower cost and a lower cash outlay. Thus, the end user 12 can allocate more of their budget to the cost of the making the modifications to the land. For example, the end user 12 can allocate more of their budget to building their actual dwelling. This means that persons who do not have sufficient capital to purchase a house with land can still own their own home. The potential home owner can raise money to make modifications to the land by taking out a mortgage, if required, using the modifications as collateral.

The lease agreement may be offered for any predetermined period (e.g., 99 years) with rollover provisions. During the period of the lease agreement, fees may be payable by the end user 12 to the trust 14. As described above, the fees may be calculated and paid periodically (e.g., weekly, monthly, annually), in advance or in arrears. The fees may be calculated as a percentage of the value of the land at the date of entering into the lease agreement or at the date that the fee is due. The fees may be based on the higher of the current valuation of the land or the original purchase price of the land compounded with a minimum annual increase. The fees may also be based on any pre-existing modifications to the land and which are being leased to the end user 12.

The valuation of the land, the determination of the amount of the fees and the tracking of when the fees are due may be implemented as one or more software modules resident in the hard disk drive 210 and being controlled in their execution by the processor 205 of the computer system 200. After some period (e.g., one (1), two (2), three (3) or five (5) years etc) the land may be re-valued using any suitable method, and the fees payable by the end user 12 to the trust 14 may be calculated on the new valuations. The valuations and revaluations of the land, as described above, may be implemented as one or more software modules resident in the hard disk drive 210 of the computer system 200 and being controlled in its execution by the processor 205.

In one embodiment, the end user 12 may also be given an option by the trust 14 to purchase the land and any modifications which are owned by the trust 14. This option to purchase the land may be offered periodically (e.g., every one (1), two (2), three (3) or five (5) years etc). The option to purchase the land may be based on the higher of a current valuation of the land, or the original purchase value of the land compounded with an annual increase. Methods of determining (or forecasting) the value of land at a predetermined time in the future, in accordance with one or more of the described embodiments, will be described below.

In the event of default on lease payments by the end user 12, the trust 14 may appoint an agent to manage sale of the modifications (e.g., a dwelling) and transfer of the lease to the new owner of the modifications such as the dwelling. The proceeds of the sale go to the defaulting owner (i.e., the end user 12) of the modifications (e.g., dwelling), subject to payment of any outstanding lease payments, reasonable costs of conducting and managing the sale, and accounting to any mortgagee on the house or modifications, for example a bank. Alternatively, any other suitable method of dealing with the defaulting owner may be used.

### 2. Existing Home Owners

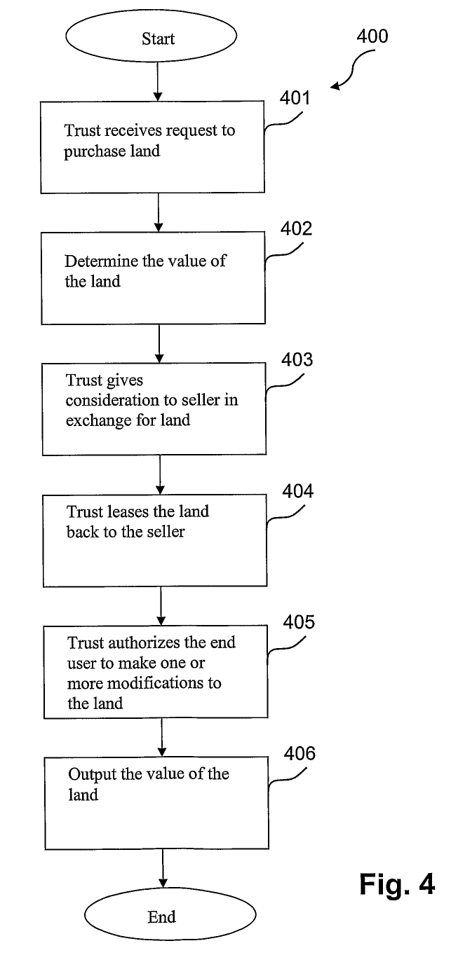

A method 400 of buying land, according to another embodiment, will now be described with reference to FIG. 4. In this embodiment, end users 12 are owners who may currently own some land and/or a dwelling and/or other structure built upon that land. That is, the land may have pre-existing modifications owned by the end user 12.

The method 400 begins at step 401, where a seller, being the end user 12, makes contact with the operator of the trust 14 and requests that the trust 14 purchase land (and any pre-existing modifications) already owned by the end user 12 for the purpose of making the land available to the end user 12. The seller agrees to sell their land to a buyer being the trust 14 based on the value of the land excluding any pre-existing modifications made to the land. Again, upon being approached by the end user 12, the trust 14 would typically create a record, corresponding to the end user 12, in a database configured within the hard disk drive 210, for example

At the next step 402, the seller and/or the trust 14 has the land valued, for example, by an independent valuator as per step 302 described above. Again, the value of the land is determined excluding any pre-existing modifications that have been made to the land. The trust 14 may also have any pre-existing modifications valued. Accordingly, again, the trust 14 determines the value of the property (i.e., the land and any pre-existing modifications). However, the value of the pre-existing modifications may be determined as a separate value. The value(s) determined at step 402 may also be recorded in the database against the record for the end user 12.

At the next step 403, the trust 14 gives consideration to the end user 12 (i.e., the seller) of the land in exchange for the land. The consideration is an amount of money commensurate to the value of the land determined as described above in step 402. Typically, the trust 14 will hold title to both the land and/or any pre-existing modifications (e.g., a dwelling) made to the land depending on the jurisdication. However, at the next step 404, the trust 14 provides the land to the end user 12 (i.e., the seller/previous owner) under a lease agreement allowing the end user 12 to access and use the land. Again, the land may be made available to the end user 12 under any other suitable occupancy and/or use agreement, or other suitable legal instrument. The lease agreement (or any other suitable legal instrument) may also provides the end user's 12 ownership of any pre-existing modifications (e.g., a dwelling) made to the land.

Then at the next step 405, the trust 14 authorises (or allows) the end user 12 to have one or more further modifications, as described above, made to the land, as if the end user still owned the land. Again, the authorisation by the trust 14 at step 405 is preferably made under the lease agreement. That is, the lease agreement includes terms which authorise the end user 12 to have one or more modifications or further modifications made to the land.

In accordance with the method 400, under the agreement, the trust 14 retains ownership of the land and is entitled to the value of the land as determined at step 402 or as periodically determined. Also, under the lease agreement, the end user 12 retains the rights to use and occupy the land. The end user 12 also retains ownership of any modifications made to the land (i.e., including pre-existing modifications and modifications made by the end user 12 during the period of the agreement).

The method 400 concludes at the next step 406, where the value of the land determined at step 402 is output, in order to notify the trust 14, the investors 16 and/or the end user 12, for example of the value of the land. This output or notification may take any suitable form. For example, the value of the land may be included in a report which is printed on the printer 215 and distributed to each of the trust 14, investors 16 and/or to the end user 12.

In a similar manner to the method 300, as described above, during the period of the lease agreement entered into in step 404, the value of the land may be determined on a periodic basis (e.g., every three or six months), for the purpose of notifying (or outputting to) investors 16 periodically of the value of the assets owned and controlled by the trust 14. These investors 16 may be the holders of Pension Benefit Units, as will be described below. Accordingly, on a periodic basis, the trust 14 may determine the value of the property excluding modifications made to the land by the end user 12 (i.e., a second party to whom the property is being leased) during a non-expired or expired period of the lease agreement.

Further, during the period of the agreement, the value of the land at a predetermined time (e.g., 25 years in the future) may also be determined for use in investment prediction and, in particular, in land value prediction. The value of the land may also be determined in order to determine the value of fees payable by the end user 12 to the trust 14 for leasing the land. In this instance, the fees may be calculated as a percentage of the value of the land at the date of entering into the lease agreement or at the date that the fee is due. The fees may be based on the higher of the current valuation of the land or the original value of the land compounded with a minimum annual increase.

In one embodiment, the trust 14 may issue a license to an end user 12 in order to perform the methods described herein. For example, the end user 12 may contact the trust 14 and obtain a license from the trust 14 to perform the method 300 or even the method 400. In this instance, the trust 14 may supply the end user 12 with relevant documentation in order to enable the end user 12 to perform the method 300. This documentation may include an outline of the methods described herein together with any other documentation, such as template lease agreements and the like. In this embodiment, the end user 12 may already own the land including some pre-existing modifications. Alternatively, land and modifications may be acquired by the end user 12 in the traditional way (e.g., through a standard mortgage with a bank). The end user 12 may then enter into a lease agreement with a third party for the purpose of making the land and pre-existing modifications available to the third party in accordance with the method 300. The end user 12 authorises (or allows) the third party to have one or more modifications or further modifications made to the land. As described above, such modifications may include building a structure on the land, demolishing and/or modifying an existing structure built on the land, subdividing the land, and/or landscaping an area around a structure built on the land. Upon the modifications or further modifications being made to the land, the third party retains ownership to the further modifications made to the land during the period of the agreement, together with the rights to use and occupy the land. In exchange for the license to perform the method 300, the trust 14 may be given the right to purchase the land from the end user 12 at the end of the occupancy and use agreement made between the end user 12 and the third party, or at some other agreed time. Accordingly, in this embodiment, the end user 12 may keep the land and sell their interest in any modifications (i.e., pre-existing or made during the period of the agreement).

### 3. Existing Strata Titled Property Owners.

In another embodiment of the method 400, groups of end users 12, usually represented by their respective strata body manager, currently own and/or use land upon which their dwellings are already constructed (i.e., the land includes pre-existing modifications) or are proposed to be constructed (i.e., the end users 12 wish to make modifications to the land. Using the method 400, these groups of end users 12 (i.e., sellers) can sell their interest in the land to a buyer being the trust 14 based on the value of the land excluding any pre-existing modifications. In purchasing the land, the sellers and/or the trust 14 has the land valued, for example, by an independent valuer. Again, the value of the land is determined excluding any pre-existing modifications that have been made to the land. However, the trust 14 may also have any pre-existing modifications valued.

As at step 402, the trust 14 gives consideration to the end users 12 being an amount of money commensurate to the value of the land determined as described above. The trust 14 then leases the land back to the end users 12 on any suitable terms. The trust 14 authorises (or allows) the end users 12 to have one or more modifications or further modifications made to the land, as at step 405. Under the lease agreement, the end users 12 retain the rights to use and occupy the land. Although, the trust 14 would typically hold title to the land and the pre-existing modifications, under the agreement, the end users 12 retains ownership to any modifications made to the land (i.e., including pre-existing modifications and modifications made by the end user 12 during the period of the agreement).

In a similar manner to the method 300, as described above, during the period of the lease agreement, the value of the land may be determined on a periodic basis (e.g., every three or six months), for the purpose of notifying investors 16 periodically of the value of the assets owned and controlled by the trust 14. Further, during the period of the agreement, the value of the land at a predetermined time (e.g., 25 years in the future) may also be determined for use in investment prediction and, in particular, in land value prediction. The value of the land may also be determined in order to determine the value of fees payable by the end users 12 to the trust 14 for leasing the land. In this instance, as described below, the fees may be calculated as a percentage of the value of the land at the date of entering into the lease agreement or at the date that the fee is due. The fees may be based on the higher of the current valuation of the land or the original value of the land compounded with a minimum annual increase.

The end users 12 may sell their interest in the modifications. Accordingly, the owners may sell their collective or individual interest in the modifications made to the land knowing that their continuing usage and occupancy of that land is guaranteed. As the trust 14 typically holds the title to the land and the modifications, upon the sale of the modifications, a new lease agreement may be entered into between the trust 14 and the new owner of the modifications. The transfer of the ownership of the modifications to the new owner may be effected by the lease agreement or any other suitable legal instrument. The original owners of the modifications may also have a collective obligation such as the obligation to pay the lease fees to the trust 14. Such collective obligations, or a portion of such collective obligations, may be transferred in the new lease agreement between the trust 14 and the new owner of the modifications upon the modifications being sold to the new owner.

In one embodiment, the new owner of the modifications may be the trust 14. That is, the end users 12 may sell their interest in the modifications to the trust 14.

### 4. Government, Semi Government, Local Government and Council Property Owners.

In one embodiment of the method 400, the end users 12 are government, semi government, local government and council owners of land for use by many people, special interest groups and the general public (e.g., parks, sporting ovals, swimming pools, memorials, public walkways, recreation areas etc). In this embodiment, the end users 12 (i.e., sellers) sell their interest in the land to a buyer being the trust 14 based on the value of the land excluding any pre-existing modifications. In purchasing the land, the end user 12 and/or the trust 14 has the land valued, for example, by an independent valuator. Again, the value of the land is determined excluding any pre-existing modifications that have been made to the land. However, the trust 14 may also have any pre-existing modifications valued.

The trust 14 gives consideration to the end users 12 being an amount of money commensurate to the value of the land, as at step 403. As at step 404, the trust 14 then provides the land to the end users 12 under a lease agreement or any other suitable occupancy and/or use agreement, or other suitable legal instrument, on any suitable terms. Under the lease agreement, the end users 12 retain ownership of the pre-existing modifications made to the land. Under the lease agreement, the trust 14 also authorises (or allows) the end users 12 to have one or more further modifications, as described above, made to the land during the period of the agreement, as at step 405. Finally, under the lease agreement, the end users 12 retain the rights to use and occupy the land. The end users 12 also retain rights to any modifications made to the land during the period of the lease agreement.

In a similar manner to the method 300, as described above, during the period of the lease agreement, the value of the land may be determined on a periodic basis (e.g., every three or six months), for the purpose of notifying investors 16 periodically of the value of the assets owned and controlled by the trust 14. Further, during the period of the agreement, the value of the land at a predetermined time (e.g., 25 years in the future) may also be determined for use in investment prediction and, in particular, in land value prediction. The value of the land may also be determined in order to determine the value of fees payable by the end user 12 to the trust 14 for leasing the land. In this instance, as described below, the fees may be calculated as a percentage of the value of the land at the date of entering into the lease agreement or at the date that the fee is due. The fees may be based on the higher of the current valuation of the land or the original value of the land compounded with a minimum annual increase.

The end users 12 may also sell their interest in the modifications (i.e., pre-existing or made during the period (i.e., non-expired or expired period) of the agreement) at a value determined by the end user 12 or an independent valuator. Again, this interest in the modifications may be the collective interest of the end users 12. For example, the modifications may comprise a community centre built by the end users 12. Alternatively, a small group of the end users 12 may have a specific interest. For example, a special interest group of end users (e.g., a golf club) may build a sporting facility (e.g., a golf course) and sell their interest in the golf course, while the trust 14 still owns the land upon which the golf course is built.

Accordingly, in this embodiment, the end users 12 (i.e., government, semi government, local government and council) may effectively sell their interest in the land knowing that continuing usage for the public is maintained and guaranteed. The end users 12 may also have a collective obligation, such as the obligation to maintain a public golf course or swimming pool. Such collective obligations, or a portion of such collective obligations, may be transferred to the new owners of the modifications under a new lease agreement (or other suitable legal instrument) entered into between the trust 14 and the new owners upon the land being sold.

Again, the new owners of the modifications may be the trust 14. That is, the end users 12 may sell their interest in the modifications to the trust 14.

5. Private Park Owners, such as Community Titled Developed Properties.

In one embodiment of the method 400, the end users 12 are private park (or community) owners, such as the owners of community titled shared usage parks, or owners of community used common areas. In this embodiment, community owners of property sell their interest in the land to a buyer being the trust 14 based on the value of the land excluding any pre-existing modifications. In purchasing the land, the sellers and/or the trust 14 has the land valued, for example, by an independent valuator. Again, the value of the land is determined excluding any pre-existing modifications that have been made to the land. However, again, the trust 14 may also have any pre-existing modifications valued. Accordingly, again, the trust 14 determines the value of the property (i.e., the land and any pre-existing modifications).

As at step 403, the trust 14 gives consideration to the end users 12 being an amount of money commensurate to the value of the land determined as described above. As at step 404, the trust 14 leases the land back to the end users 12 on any suitable terms. The trust 14 authorises (or allows) the end users 12 to make any modifications or further modifications, as described above, to the land, as at step 405. Under the lease agreement, the end users 12 retain the rights to use and occupy the land. The end users 12 also retain ownership of any modifications made to the land (i.e., including pre-existing modifications and modifications made by the end user 12 during the period of the agreement).

In a similar manner to the method 300, as described above, during the period of the lease agreement, the value of the land may be determined on a periodic basis (e.g., every three or six months), for the purpose of notifying investors 16 periodically of the value of the assets owned and controlled by the trust 14. Accordingly, on a periodic basis, the trust 14 may determine the value of the property excluding modifications made to the land by the end user 12 (i.e., a second party to whom the property is being leased) during a non-expired or expired period of the lease agreement.

Further, during the period of the agreement, the value of the land at a predetermined time (e.g., 25 years in the future) may also be determined (or forecast) for use in investment prediction and, in particular, in land value prediction. The value of the land may also be determined in order to determine the value of fees payable by the end users 12 to the trust 14 for leasing the land. In this instance, as described below, the fees may be calculated as a percentage of the value of the land at the date of entering into the lease agreement or at the date that the fee is due. The fees may be based on the higher of the current valuation of the land or the original value of the land compounded with a minimum annual increase.

Again, the end users 12 may sell their interest in the modifications or further modifications at a determined value. Again, this interest in the modifications may be the collective interest of the end users 12 or the specific interest of a small group of the ender users 12. Further, again, the new owner of the modifications may be the trust 14.

Accordingly, in this embodiment, the end users 12 may sell their interest in the land knowing that continuing usage for the community is maintained and guaranteed.

### Loan Advance for Purchasing Land

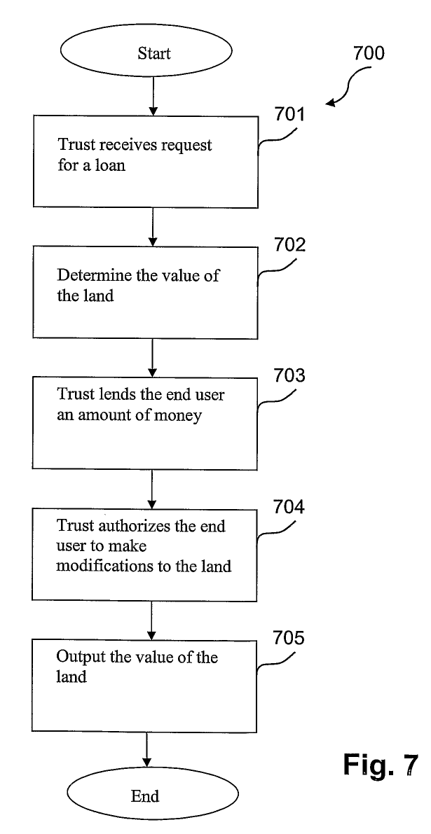

A method 700 of providing land usage and occupation rights so as to facilitate the making of one or more modifications to the land, according to another embodiment, will now be described with reference to FIG. 7. As described above, such modifications may include building a structure on the land, demolishing and/or modifying an existing structure built on the land, subdividing the land, and/or landscaping an area around a structure built on the land. Again, such modifications may be referred to as improvements in some instances. As also described above, the structure may include, for example, a house and/or other dwelling (e.g., dual and/or multiple occupancy), a factory, an office and/or other building, a driveway, parking facilities, retaining walls, sporting facilities (e.g., pool, tennis court, running track) and access facilities (e.g., a stair case, an inclinator, a lift).

The method 700 begins at step 701, where an end user(s) 12 finds an area of land that they wish to use and/or occupy. The land may or may not already have pre-existing modifications (e.g., a structure on the land). The end user 12 makes contact with the operator of the trust 14 and requests that the trust 14 lend the end user 12 an amount of money equal to the value of the land excluding any pre-existing modifications (e.g., pre-existing house and/or other dwelling) made to the land. Again, upon being approached by the end user 12, the trust 14 would typically create a record, corresponding to the end user 12, in a database configured within the hard disk drive 210, for example.

At the next step 702, the trust 14 determines the value of the land. Typically, at step 702, the land is valued by an independent valuator, for example. In this instance, the value of the land is determined excluding any pre-existing modifications that have been made to the land. However, the value of any pre-existing modifications may also be determined. Accordingly, the trust 14 determines the value of the property (i.e., the land and any pre-existing modifications). The value determined at step 702 may also be recorded in the database against the record for the end user 12.

At the next step 703, the trust 14 lends the end user 12 an amount of money equal to the value of the land, excluding any pre-existing modifications, and enters into an agreement (e.g., occupancy and use agreement) with the end user 12 using the land as security for the loan advance. The terms of such an agreement will be described in detail below. The trust 14 registers their interest in the land bought by the end user 12.

The end user 12 may also enter into an agreement, for example, with a bank for building of the structure or making any other modifications to the land. For example, the end user may enter into a mortgage loan with the bank.

Then at the next step 704, the trust 14 authorises (or allows) the end user 12 to have one or more modifications or further modifications, as described above, made to the land. For example, this can be either by way of building a structure, or modifying an existing structure on the land. Again, the authorisation by the trust 14 at step 704 is preferably made under the agreement entered into between the trust 14 and the end user 12 at step 703. That is, the agreement entered into at step 703 includes terms which authorise the end user 12 to have one or more modifications or further modifications made to the land.

Further, under the agreement entered into at step 703, the end user 12 retains the rights to use and occupy the land. The end user 12 also retains ownership to any modifications made to the land (i.e., including pre-existing modifications and modifications made by the end user 12 under the agreement).

The method 700 concludes at the next step 705, where the value of the land determined at step 702 is output, in order to notify the trust 14, the investors 16 and/or the end user 12, for example, of the value of the land. This output or notification may take any suitable form. For example, the value of the land may be included in a report which is printed on the printer 215 and distributed to each of the trust 14, investors 16 and/or to the end user 12.

In a similar manner to the method 300, as described above, during the period of the lease agreement, the value of the land may be determined on a periodic basis (e.g., every three or six months), for the purpose of notifying (or outputting to) investors 16 periodically of the value of the assets owned and controlled by the trust 14. Accordingly, on a periodic basis, the trust 14 may determine the value of the property excluding modifications made to the land by the end user 12 (i.e., a second party to whom the property is being leased) during a non-expired or expired period of the lease agreement.

Further, during the period of the agreement, the value of the land at a predetermined time (e.g., 25 years in the future) may also be determined for use in investment prediction and, in particular, in land value prediction. The value of the land may also be determined in order to determine the value of fees payable by the end user 12 to the trust 14 for leasing the land. In this instance, as described below, the fees may be calculated as a percentage of the value of the land at the date of entering into the lease agreement or at the date that the fee is due. The fees may be based on the higher of the current valuation of the land or the original value of the land compounded with a minimum annual increase.

The end user 12 retains ownership of any modifications made to the land be they preexisting, or made during the period the agreement, together with the rights to use and occupy the land. Again, the end user 12 may sell their interest in the modifications made to the land for a determined value. In this instance, the end user 12 is entitled to the proceeds of such a sale subject to payment of any outstanding lease payments, reasonable costs of conducting and managing the sale, and accounting to any mortgagee lender, for example, a bank.

The occupancy and use agreement preferably runs for an indefinite period. During the period of the agreement, fees are paid by the end user 12 to the trust 14. The fees may be calculated and paid periodically (e.g., weekly, monthly, annually), in advance or in arrears. The fees may be calculated as a percentage of the market value of the land at the time that the fee is paid. For example, the fees may consist of an annual payment equal to a percentage of the value of the land. The determination of the amount of the fees and the monitoring of the fee payments may be implemented as one or more software modules resident in the hard disk drive 210 and being controlled in their execution by the processor 205.

In the event that the modifications (e.g., a structure such as a dwelling on the land) is sold because of default on a mortgage by the end user 12 with the trust 14, the trust 14 may appoint an agent to manage sale of the modifications made to the land (e.g., a structure built on the land). The proceeds of the sale go to the end user 12 that owned the modifications, subject to payment of any outstanding fee payments, reasonable costs of conducting and managing the sale, and accounting to any lender on the structure or modifications, for example, a bank. The end user 12 that owned the structure would be discharged from making any further fee payments to the trust 14. Further, ownership of the land may be transferred to the trust 14 and the land may be leased to the new owner of the structure in a similar manner to that described above with reference to FIGS. 3 and 4.

In one embodiment of the method 700, the end user 12 may also be given an option by the trust 14 to discharge the loan advance. This option to discharge the loan advance may be offered periodically (e.g., every five (5) years). The option to discharge the loan advance may be based on the higher of the current valuation of the land, or the original value of the land compounded with an annual increase. Methods of determining or forecasting the value of land at a predetermined time in the future, in accordance with one or more of the described embodiments, will be described below.

The methods described above require the valuation of the land at different times including, for example, when an option to discharge the loan advance is offered to an end user 12 of a dwelling built on the land leased to the end user 12 by the trust 14 as described above.

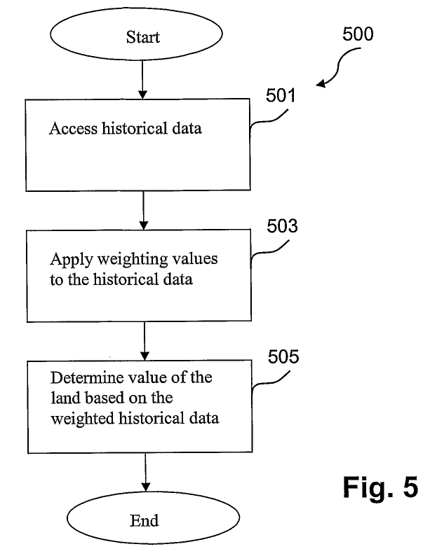

A method 500 of determining (or forecasting) the value of land at a predetermined time (e.g., in twenty five years in the future) will now be described in detail by way of example with reference to FIGS. 5 and Appendices A and B.

The method 500 may be implemented as software resident in the hard disk drive 210 and being controlled in its execution by the processor 205. Values determined at each step of the method 500 may be stored in a database configured within the hard disk drive 210. This database may include a record for each land holding and/or a particular end user 12 of a particular land holding.

The described method 500 of determining the value of the land at a predetermined time is flexible and adaptable for application and use in investment prediction and, in particular, in land value prediction. In the method 500, the historical annual growth in the value of the land is determined and compounded. The historical annual growth in the value of land will vary in different market segments (e.g., New South Wales, Victoria, metropolitan areas, regional areas etc) as well as the type of land.

The method 500 produces valuation statistics for the land in periodical increments (e.g., one year, five years etc). Preferably, valuation predictions are based on historical data of equivalent time frame (e.g., one year, five years etc). This historical data may include indices such as Residex, Reserve Bank of Australia indices, fifty (50) year average growth of house values, Consumer Price Index (CPI) and market bond rates (e.g., Commonwealth long term bond rates, United States long term bond rates), birth and migration rates, environmental factors, marriage statistics, unemployment figures and the rate of compulsory superannuation. There are also some specific influences that may be considered in determining the value of land at a predetermined time. These special influences include international political issues, national political issues, state political issues, regional and local issues such as the possibility of war, changes in the rates of taxation, share market cycles, and suitability of infrastructure (or lack of suitable infrastructure). Each property market used for determining the historical annual growth in the value of land may be divided into a number of segments, as described below. For example, the property market in New South Wales, Australia, may be divided up as follows:

(i) Metropolitan New South Wales:
Sydney residential land;
other metropolitan residential;
metropolitan retail;
industrial sites; and
semi-rural Sydney (residential).

(ii) Regional New South Wales
retail;
coastal cities, inland cities—(single dwelling sites);
industrial sites;
agricultural (different applications); and
rural home sites.

The property market in other countries and their individual regions may be similarly divided up as described above. Each market segment requires individual market statistics to be used to determine growth values as the markets vary significantly.

The method 500 may be implemented as software resident in the hard disk drive 210 and being controlled in its execution by the processor 205. The method 500 of determining the value of land at a predetermined time begins at step 501, where the processor 205 accesses historical data, as described above, for a predetermined period (e.g., twenty five (25) years). This historical data may be stored in a database configured within the hard disk drive 210. Alternatively, the historical data or a portion thereof may be accessed by the processor 205 over the network 220.

At the next step 503, weighting values are applied to the historical data depending on current economic factors. For example, a weighting value may be applied to the historical inflation rate to reduce the effect of the inflation rate on the method 500 if historical inflation rates have been consistently low over the predetermined period and are likely to stay low up until the predetermined time. The weighting values applied at step 503 may be predetermined and stored in memory 206, for example. Appendix C, which will be described in detail below, includes a table showing how external historical data may be weighted.

At the next step 505, the processor 205 determines the value of the land at the predetermined time based on the weighted historical data. Any suitable valuation model may be used at step 505 to determine the value of the land at the predetermined time based on the weighted historical data. The value determined at step 505 may then be stored in the hard disk drive 210, for example, associated with the record of an end user 12.

An example of the increasing value of a land holding over a period of seventy five (75) years will be described in detail below with reference to Tables 1 and 2 as shown in Appendix A. Table 1 is a summary of the information in Table 2. In the example of Appendix A, the initial land value is $250,000 and an average growth of 7.00% per annum is assumed. The land is leased under a lease agreement for a term of one hundred and ninety nine (199) years.

Another example of the increasing value of a land holding over a period of seventy five (75) years will also be described in detail below with reference to Tables 3 and 4, as shown in Appendix B. Table 3 is a summary of the information in Table 4. In the examples of Appendix B, the initial land value is $100,000 and an average growth of 7.00% per annum is assumed. Again, the land is leased under a lease agreement for a term of one hundred and ninety nine (199) years.

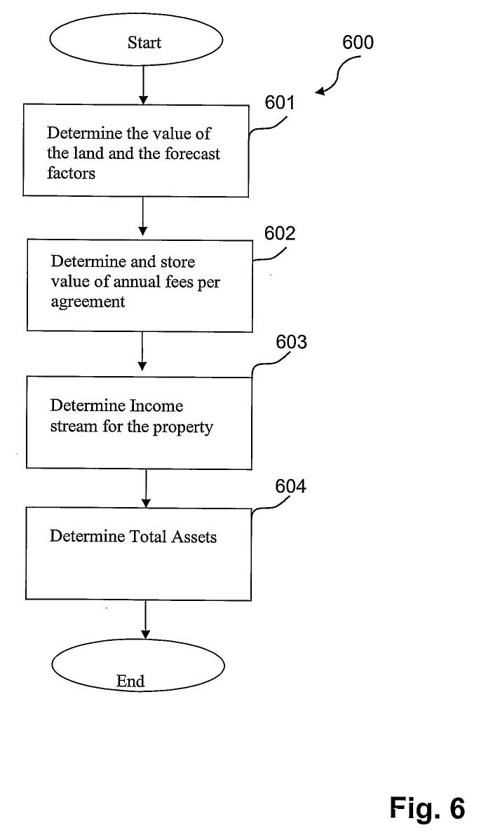

A method 600 of estimating an income stream for land leased over a predetermined period (e.g., one hundred and ninety nine (199) years) as described above, will be described in detail below with reference to FIG. 6 and the examples of Appendices A and B. The income stream for the land may be determined based on the value of the land determined in accordance with the method 500. The income will include the value of the lease (or rental) fees paid to the trust 14 by end user 12 for leasing the land during the predetermined period of the lease agreement. The income may be estimated for each year over the predetermined period of the agreement.

Again, the method 600 may be implemented as software resident in the hard disk drive 210 and being controlled in its execution by the processor 205. Values determined at each step of the method 600 may be stored in the database configured within the hard disk drive 210. This database again may include a record for each land holding and/or a particular end user 12 associated with a particular land holding.

The method 600 of estimating an income stream for land leased over a predetermined period begins at step 601, where the processor 205 accesses the hard disk drive 210 to determine the value of the land determined in accordance with the method 500, together with the estimated capital appreciation over a predetermined period as also determined as described above in accordance with the method 500. Other relevant historical data, as described above, may also be accessed at step 601. For example, the most relevant historical data for the method 600 may include the inflation rates. Again, this historical data may be stored in a database configured within the hard disk drive 210 or be accessed by the processor 205 over the network 220.

Then at the next step 602, the processor 205 determines the value of lease (or rental) fees that are required to be paid to the trust 14 under a lease agreement entered into between the trust 14 and an end user 12 associated with the land. These lease fee values may be stored in the database configured within the hard disk drive 210, for example. In the examples of Appendices A and B, the land is leased at a lease fee rate of 5.25% per annum of the value of the land for a particular year. The lease agreement also includes a honeymoon period of five years in which time the lease fees remain fixed at 5.25% of the initial value of the land. Under the terms of the lease agreement the land is valued annually.

At the next step 603, the processor 205 determines income values for each year of the predetermined period including the value of the lease fees paid to the trust 14. In the example of Appendix A, the lease fee rate and honeymoon period produces an income as shown in the column “Income” of Table 2. The income earned from the lease fees for the first five years is $13,125 per annum due to the honeymoon period. The income earned from the lease fees for each subsequent year after five years is then determined as 5.25% of the value of the land in that year.

Similarly, in the example of Appendix B, the lease fee rate and honeymoon period produces an income as shown in the column “Income” of the Table 3. The income for the first five years is $5,250 per annum due to the honeymoon period. The income earned from the lease fees for each subsequent year after five years is then determined as 5.25% of the value of the land in that year.

In the example of Appendix A, the trust 14 also pays an annual coupon in arrears to a party (lender or investor 16) that provided the trust 14 with the initial $250,000 to purchase the land. This party may be the holder of a Pension Benefit Unit which will be described in detail below. The coupon is valued at 3.00% of the initial value of the land. Accordingly, an annual coupon of $7,500 is paid out, as seen in the column marked “Coupon” in the Table 2. In contrast, no coupon fee is paid in the example of Appendix B.

Residual income for the land is also determined as the income earned from the lease fees (i.e., Income) minus the value of the coupon (i.e., Coupon) plus any interest paid on the amount, as seen in the column marked “Residual Income” in Tables 2 and 4. In the examples of Appendices A and B, a Cash Rate of 3.5% per annum is assumed. Accordingly, the residual income is compounded each year as shown in the columns marked “Cash Compound Residual Income” in Tables 2 and 4 based on the Cash Rate. Again, the income values determined at step 603 may be stored in the database configured within the hard disk drive 210.

The method 600 then concludes at the next step 604, where the processor 205 determines a total net asset value associated with the land for each year of the agreement. These total net asset values may be stored in a database configured within the hard disk drive 210. The total net asset value for a particular year is equal to the land value (i.e., Value) determined for that year plus the cash compound residual income (i.e., Cash Compound Residual Income). As seen in the column marked “Total Assets” of Table 2 of Appendix A, the total net asset value for year six (6) of the agreement is equal to $421,130 which is made up of the land value (i.e., Value) of $375,183 plus the cash compound residual income (i.e., Cash Compound Residual Income) of $45,947. Similarly, as seen in the Table 4 of Appendix B, the total net asset value for year six (6) of the agreement is equal to $189,451 which is made up of the land value (i.e., Value) of $150,073 plus the cash compound residual income (i.e., Cash Compound Residual Income) of $39,379.

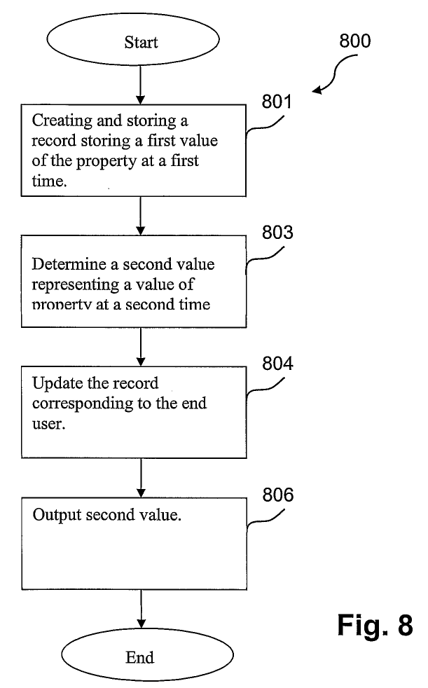

A method 800 of determining the value of a property will now be described with reference to FIG. 8. The property includes land owned by the trust 14 (a first party). Values determined at each step of the method 800 may be stored in a database configured within the hard disk drive 210. This database may include a record for each land holding (or property) and/or a particular end user 12 of a particular land holding (or property). The method 800 may be implemented as software resident in the hard disk drive 210 and being controlled in its execution by the processor 205.

The method 800 begins at the first step 801, where a record corresponding to the end user 12 (a second party), to whom the property is being leased, is created and stored in the hard disk drive 210, by the trust 14. The property is being leased to the end user 12 under a lease agreement (or any other suitable legal instrument) between the trust 14 and the end user 12, as described above. The record includes at least a first value representing value of the property at a first time. This first time is the time that the land is purchased by the trust 14 and/or the time that the land is leased by the end user 12. The value of the property is determined at step 801 excluding any pre-existing modifications made to the land. However, the value of any such pre-existing modifications may also be determined, particularly if the trust 14 owns the pre-existing modifications.

The method 800 is continued at the next step 803, where a second value representing value of the property at a second time is determined. The second value is determined excluding modifications made to the land by the end user 12 (i.e., a second party) in a period between the first time and the second time. The second time, in this instance, may be the time that the end user 12 sells the modifications, be they pre-existing, if the end user 12 purchased the pre-existing modifications, or those modifications made to the land during the period. The second time may also occur during the period of the lease agreement when the value of the land is determined on a periodic basis for the purpose of notifying investors 16. The second time may also be at a predetermined time in the future (e.g., 25 years in the future) for use in investment prediction.

At the next step 804, the record corresponding to the end user 12 (second party) is updated according to the second value. This update may be performed at the second time or any subsequent time.

The method 800 concludes at the next step 806, where the second value is output. Again, the second value may be output in order to notify the trust 14, the investors 16 and/or the end user 12, for example, of the value of the property including the land. Again, this output or notification may take any suitable form. For example, the value of the property may be included in a report which is printed on the printer 215 and distributed to each of the trust 14, investors 16 and/or to the end users 12. Such a report on the value of the property may be distributed over the communications network 220, for example, in the form of an email. The value of the property may also be displayed on the display device 214 or transmitted over the communications network 220 for display on other display devices connected to the network 220.

In accordance with an agreement entered into between the trust 14 and the end user 12, the trust 14 (or first party) retains ownership of the land and is entitled to an amount based on the output second value. Further, the end user 12 (or second party) retains ownership of the modifications made to the land during the period and is entitled to an amount based on a value of the modifications made to the land during the period.

The methods described above essentially create a separation between the land and the modifications (or improvements) made to the land. Although, the trust 14 would typically hold title to a land holding, under the lease agreements (or any other suitable legal instrument), the methods allow for separate legal, economic and/or beneficial rights to the modifications (i.e., separate ownership of the modifications). Capital appreciation on the modifications is enjoyed by the owner of the modifications, in the methods described above. In each of the described methods, the owner of the modifications made on land leased as described above, may lease the modifications to a third party (i.e., a modifications tenant). This lease may be termed a “modifications lease”.

### Pension Benefit Units

The described methods allow the land to be held by the trust 14 for a long period of time (e.g., hundreds of years). This unique nature of the land interests held by the trust 14 means that certain future promises can be made and/or guaranteed. For example, the known historical growth of land assets held by the trust 14 enables, via use of the described structure and methods, a predictable future value of assets to be determined. Based on these future values and the described structure it is possible to determine and make promises and/or guarantees of future value to one or more of the investors 16. These financial promises are made in the form of special financial instruments, called Pension Benefit Units, which may be issued to entities in the capital markets. The Pension Benefit Units are asset backed and, as such, are highly secure. The Pension Benefit Units may be in various forms (e.g., promissory redemption Pension Benefit Units, lump sum Pension Benefit Units, reducing balance Pension Benefit Units).

The value of a Pension Benefit Unit may be referred to as the Pension Benefit Unit's “redemption value”. Each of the Pension Benefit Units represents a promise by the trust 14 to pay an investor 16 (to whom the particular Pension Benefit Unit has been issued) an amount of money at the predetermined time (i.e., the maturity date of the particular Pension Benefit Unit). This amount is equal to at least a portion of the total income assigned to that particular Pension Benefit Unit.

Each of the Pension Benefit Units may be issued to one or more of the investors 16. For example, a Pension Benefit Unit may be provided by the trust 14 to a particular investor 16 at a particular time in exchange for an amount of money (e.g., the initial $250,000 to purchase the land). The Pension Benefit Unit to be provided to this individual has a redemption value equal to at least a portion of the total income of the land.

In accordance with the example of Appendix A, the Pension Benefit Unit is an “Inflation Linked Bond.” In this instance, the bond may be issued by the trust 14 to one of the investors 16 that provided the trust 14 with the initial $250,000 to purchase the land. This $250,000 is referred to as the “initial value” of the bond. In one example, the bond issued to the investor 16 has a predetermined term (or period as described above) with a fixed maturity date of fifty years. Accordingly, as seen in the column marked “Bond Obligations Debt Obligation Inflation Linked” in Table 2, the trust 14 promises to pay the investor 16 an amount of $686, 355 on maturity of the bond. This amount is determined by calculating the compounded value of the initial value using 50% of the anticipated inflation rate over the 50 year period. During this 50 year period the holder of the bond will receive an annual income of 3% of the initial value, which is $7500 per annum

In the example of Appendix A, the inflation rate is set at 4% per annum and the estimated cost of finds value (i.e., Est Cost Funds) is set at 5% of the initial value of the bond. Accordingly, the redemption value of the bond at fifty (50) years is equal to $686, 355, as seen in the column marked Total Assets. This leaves a value, referred to as the “Vault Surplus”, of $12,002,580 which is equal to the value in the Total Assets column minus the value in the Bond Obligations Debt column. In accordance with the example of Appendix B, the Pension Benefit Unit is an “Inflation Linked Zero Coupon Bond.” In this instance, the bond may be issued by the trust 14 to one of the investors 16 that provided the trust 14 with the initial $100,000 to purchase the land. Again, in the example of Appendix B, the bond issued to the investor 16 has a term (or predetermined period) of fifty years. Accordingly, as seen in the column marked “Bond Obligations Debt Obligation Inflation Linked” in Table 4, the trust 14 promises to pay the investor 16 an amount of $815, 180 on maturity of the bond. This amount is determined by calculating the compounded value of the initial value using 100% of the anticipated inflation rate over the 50 year period. During this 50 year period the holder of the bond will receive no annual income as the bond has a zero coupon rate.

In the example of Appendix B, the inflation rate is again set at 4% per annum and the estimated cost of funds value is set at 5% of the initial value of the bond. Accordingly, the redemption value of the bond at fifty (50) years is equal to $815, 180. This leaves a value, referred to as the “Vault Surplus”, of $4,413,394 which is equal to the value in the Total Assets column minus the value in the Bond Obligations Debt column.

As described above, at step 503, weighting values are applied to the historical data depending on current economic factors. Appendix C includes a Table 5 showing how external historical data such as Residex, Reserve Bank of Australia indices, fifty (50) year average growth of house values, Consumer Price Index (CPI) and market bond rates, can be weighted to determine a “Valuation Factor.” This Valuation Factor may then be applied to total asset values (i.e., Total Assets) to determine a forecast future value and an Adjusted Rental Fee.

As seen in the example of Appendix C, for an Opening Value (or initial value) of the property of $250,000, the Valuation Factor may be determined as 3.84% in Year 1. The Valuation Factor is determined by applying weightings to the historical data (or indices). For example, weightings are applied to the indices as follows:
(i) a 20.00% weighting is applied to the Residex indice (Index 1-Residex) of 1.00%;
(ii) a 20.00% weighting is applied to the Reserve Bank (Index 2-Reserve Bank) of 2.00%;
(iii) a 40.00% weighting is applied to the 50 year average growth of house sales (Index 3-50 Yr Average) of 7.00%;
(iv) a 4.00% weighting is applied to the CPI (CPI-Reserve Bank) of 4.00%; and
(v) a 16.00% weighting factor is applied to the market bond rates (Bond Rates-Markets) of 3.25%.

The weighting of the indices provides a Weighted Index of 4.08% as seen in Table 5.

Influences, as described above, are also weighted to determine an Average Weighted Influences value. For example, as seen in Table 5 of Appendix C, weightings are applied to influences as follows:

| | | |
|---|---|---|
| (i) | International Political Issues: | 60.00% |
| (ii) | National Political Issues: | 110.00% |
| (iii) | State Political Issues: | 110.00% |
| (iv) | Regional Issues: | 90.00% |
| (v) | Local Issues: | 100.00% |

The weightings applied to the influences provide an Average Weighted Influences value for Year 1 of 94.00%. The Average Weighted Influences value is then applied to the Weighted Index to provide a Valuation Factor of 3.84%. The Valuation Factor is increased by a Rental Margin of 15.00% to provide an Adjusted Rental Fee of 4.41%. Accordingly, the Estimated Annual Income for the year 1 is $11,026 (i.e., 4.41% of $250,000).

As seen in Appendix C, the weightings applied to the indices vary over the period of the agreement. As such, the Valuation Factor and the Adjusted Rental Fee also increase over the term of the agreement.

In another example, the Pension Benefit Units may be issued to the investors 16 by the trust 14 on an annual basis. Appendix D shows a schedule of Pension Benefit Units with various maturity dates for an initial $1,000 paid (i.e., investment) by an investor 16 to the trust 14. As seen in Appendix D, for the $1000 investment made in 2006 with the trust 14 for a Pension Benefit Unit having a maturity date of 2025, the notional future redemption value of the Pension Benefit Unit in 2025 is $2222.58. In still another example, Appendix E shows a schedule of Pension Benefit Units with various maturity dates based on an initial $700 investment plus monthly contributions made by the investor 16.

The Pension Benefit Units according to any one of the embodiments described above may be provided to and bought by investors 16 on a revolving basis. For example, as one Pension Benefit Unit matures and is paid out to one investor 16 at the maturity date of the Pension Benefit Unit, another Pension Benefit Unit with a future maturity date may be bought by another investor 16.

The trust 14 may issue the Pension Benefit Units at a standard face value of $1000. Alternatively, the amount paid by the investor 16 to the trust 14 for a Pension Benefit Unit may be based on a percentage of the redemption value of the Pension Benefit Unit. Following issue, the trust 14 and the investors 16 may then trade in these Pension Benefit Units. For example, a Pension Benefit Unit may be provided by the trust 14 to a particular investor 16 at a particular time (e.g., 2006) in exchange for a particular amount of money (e.g., $1000). That particular investor 16 may sell the Pension Benefit Unit to another investor 16 for a different amount of money. In this instance, the cost to this other investor for buying the Pension Benefit Unit may be based on the redemption value of the particular Pension Benefit Unit at the time of selling (i.e., a current time). In this instance, the method 900 may be executed periodically (e.g., daily, weekly, monthly etc) in order to determine the redemption values of the Pension Benefit Units. The price at which the Pension Benefit Units are traded may be based on these current redemption values. Accordingly, the Pension Benefit Units may be listed for open trading in a new market created in these Pension Benefit Units.

The trust 14 may issue Pension Benefit Units with specific maturity dates and estimated target redemption values to meet market demand to fill anticipated future pension liabilities. For example, the Pension Benefit Units may have maturity dates of twenty to fifty years, as described above.

The Pension Benefit Units may also be based on a particular land holding, as described above. In the example of Appendix A, the trust 14 may issue a Pension Benefit Unit for a particular land holding at a capital cost of $250,000, with an expected notional redemption value of $378,917 in twenty years. This redemption value will not be guaranteed but will be directly supported by the title for the particular land holding as held by the trust 14. In the event that the trust 14 does not redeem the Pension Benefit Unit or remarket the Pension Benefit Unit, the title of the land may be directly available to the holder of that Pension Benefit Unit.

In the situation that the trust 14 is wound up or defaults on a debt, the land titles held by the trust 14 may be issued to the holders of the Pension Benefit Units. This would improve the credit rating of Pension Benefit Units issued by the trust 14. The structure of the trust 14 may differ from jurisdiction to jurisdiction. However, the trust 14 is preferably structured to allow the ultimate investor 16 to have access to the actual land titles in the case of catastrophic failure of the management of the income and capital obligations of operators of the trust 14. Further, when required, due to market conditions, the trust 14 may arrange to add credit enhancement by way of capital guarantees, or capital and minimum guaranteed returns. These capital guarantees, or capital and minimum guaranteed returns will be sought from external hedge funds, investment banks or guarantee providers.

### INDUSTRIAL APPLICABILITY

It is apparent from the above that the arrangements described are applicable to the computer and data processing industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

TABLE 1
Confidential
Compound Value of Land and Income 1
Land Value

| | |
|---|---|
| Initial Land Value | $250,000 |
| Average Growth | 7.00% |
| Value at start of period | 1 |

Lease

| | |
|---|---|
| Term | 199 |
| Rate | 5.25% |
| Honeymoon Period | 5 |

Funding
Type Inflation Linked Bonds

| | | |
|---|---|---|
| Coupon | 3.00% | Annual Arrears |
| Par Plus | 50.00% | of Inflation |
| Inflation | 4.00% | Estimate |
| Term | 50 | |
| | 5.00% | Est Cost Funds |

| | |
|---|---|
| Cash Rate | 3.50% |

| | | | | | Cash | | | |
|---|---|---|---|---|---|---|---|---|
| | | | | | Compound | | Bond Obligations | |
| | | | | Residual | Residual | Total | Debt Obligation | Vault |
| Year | Value | Income | Coupon | Income | Income | Assets | Inflation Linked | Surplus |
| 0 | $250,000 | $13,125 | $7,500 | $5,625 | $5,625 | $255,625 | $255,000 | $625 |
| 10 | $491,788 | $25,819 | $7,500 | $18,319 | $109,523 | $601,311 | $310,844 | $290,467 |
| 20 | $967,421 | $50,790 | $7,500 | $43,290 | $416,219 | $1,383,640 | $378,917 | $1,004,723 |
| 30 | $1,903,064 | $99,911 | $7,500 | $92,411 | $1,092,072 | $2,995,135 | $461,897 | $2,533,238 |
| 40 | $3,743,614 | $196,540 | $7,500 | $189,040 | $2,494,114 | $6,237,728 | $563,050 | $5,674,678 |
| 50 | $7,364,256 | $386,623 | $7,500 | $379,123 | $5,324,679 | $12,688,935 | $686,355 | $12,002,580 |
| 60 | $14,486,607 | $760,547 | $7,500 | $753,047 | $10,965,365 | $25,451,972 | $836,663 | $24,615,309 |
| 70 | $28,497,348 | $1,496,111 | $7,500 | $1,488,611 | $22,133,985 | $50,631,333 | $1,019,887 | $49,611,446 |
| 75 | $39,969,005 | $2,098,373 | $7,500 | $2,090,873 | $31,302,489 | $71,271,494 | $1,126,038 | $70,145,456 |

TABLE 2

| | | | | | Cash | | | |
|---|---|---|---|---|---|---|---|---|
| | | | | | Compound | | Bond Obligations | |
| | | | | Residual | Residual | Total | Debt Obligation | Vault |
| Year | Value | Income | Coupon | Income | Income | Assets | Inflation Linked | Surplus |
| 0 | $250,000 | $13,125 | $7,500 | $5,625 | $5,625 | $255,625 | $255,000 | $625 |
| 1 | $267,500 | $13,125 | $7,500 | $5,625 | $11,250 | $278,750 | $260,100 | $18,650 |
| 2 | $286,225 | $13,125 | $7,500 | $5,625 | $16,875 | $303,100 | $265,302 | $37,798 |
| 3 | $306,261 | $13,125 | $7,500 | $5,625 | $22,500 | $328,761 | $270,608 | $58,153 |
| 4 | $327,699 | $13,125 | $7,500 | $5,625 | $28,125 | $355,824 | $276,020 | $79,804 |
| 5 | $350,638 | $13,125 | $7,500 | $5,625 | $33,750 | $384,388 | $281,541 | $102,847 |
| 6 | $375,183 | $19,697 | $7,500 | $12,197 | $45,947 | $421,130 | $287,171 | $133,958 |
| 7 | $401,445 | $21,076 | $7,500 | $13,576 | $59,523 | $460,968 | $292,915 | $168,053 |
| 8 | $429,547 | $22,551 | $7,500 | $15,051 | $74,574 | $504,121 | $298,773 | $205,348 |
| 9 | $459,615 | $24,130 | $7,500 | $16,630 | $91,204 | $550,819 | $304,749 | $246,070 |
| 10 | $491,788 | $25,819 | $7,500 | $18,319 | $109,523 | $601,311 | $310,844 | $290,467 |
| 11 | $526,213 | $27,626 | $7,500 | $20,126 | $129,649 | $655,862 | $317,060 | $338,802 |
| 12 | $563,048 | $29,560 | $7,500 | $22,060 | $151,709 | $714,757 | $323,402 | $391,355 |
| 13 | $602,461 | $31,629 | $7,500 | $24,129 | $175,838 | $778,299 | $329,870 | $448,430 |
| 14 | $644,634 | $33,843 | $7,500 | $26,343 | $202,181 | $846,815 | $336,467 | $510,348 |
| 15 | $689,758 | $36,212 | $7,500 | $28,712 | $230,894 | $920,652 | $343,196 | $577,455 |
| 16 | $738,041 | $38,747 | $7,500 | $31,247 | $262,141 | $1,000,182 | $350,060 | $650,121 |
| 17 | $789,704 | $41,459 | $7,500 | $33,959 | $296,100 | $1,085,804 | $357,062 | $728,743 |
| 18 | $844,983 | $44,362 | $7,500 | $36,862 | $332,962 | $1,177,945 | $364,203 | $813,742 |
| 19 | $904,132 | $47,467 | $7,500 | $39,967 | $372,929 | $1,277,061 | $371,487 | $905,574 |
| 20 | $967,421 | $50,790 | $7,500 | $43,290 | $416,219 | $1,383,640 | $378,917 | $1,004,723 |
| 21 | $1,035,141 | $54,345 | $7,500 | $46,845 | $463,063 | $1,498,204 | $386,495 | $1,111,709 |
| 22 | $1,107,600 | $58,149 | $7,500 | $50,649 | $513,712 | $1,621,313 | $394,225 | $1,227,088 |
| 23 | $1,185,132 | $62,219 | $7,500 | $54,719 | $568,432 | $1,753,564 | $402,109 | $1,351,455 |
| 24 | $1,268,092 | $66,575 | $7,500 | $59,075 | $627,507 | $1,895,598 | $410,151 | $1,485,447 |
| 25 | $1,356,858 | $71,235 | $7,500 | $63,735 | $691,242 | $2,048,100 | $418,355 | $1,629,745 |
| 26 | $1,451,838 | $76,222 | $7,500 | $68,722 | $759,963 | $2,211,801 | $426,722 | $1,785,080 |
| 27 | $1,553,467 | $81,557 | $7,500 | $74,057 | $834,020 | $2,387,487 | $435,256 | $1,952,231 |
| 28 | $1,662,210 | $87,266 | $7,500 | $79,766 | $913,786 | $2,575,996 | $443,961 | $2,132,035 |
| 29 | $1,778,564 | $93,375 | $7,500 | $85,875 | $999,661 | $2,778,225 | $452,840 | $2,325,385 |
| 30 | $1,903,064 | $99,911 | $7,500 | $92,411 | $1,092,072 | $2,995,135 | $461,897 | $2,533,238 |
| 31 | $2,036,278 | $106,905 | $7,500 | $99,405 | $1,191,476 | $3,227,755 | $471,135 | $2,756,619 |
| 32 | $2,178,818 | $114,388 | $7,500 | $106,888 | $1,298,364 | $3,477,182 | $480,558 | $2,996,624 |
| 33 | $2,331,335 | $122,395 | $7,500 | $114,895 | $1,413,259 | $3,744,594 | $490,169 | $3,254,425 |
| 34 | $2,494,528 | $130,963 | $7,500 | $123,463 | $1,536,722 | $4,031,250 | $499,972 | $3,531,278 |
| 35 | $2,669,145 | $140,130 | $7,500 | $132,630 | $1,669,352 | $4,338,498 | $509,972 | $3,828,526 |
| 36 | $2,855,986 | $149,939 | $7,500 | $142,439 | $1,811,791 | $4,667,777 | $520,171 | $4,147,606 |
| 37 | $3,055,905 | $160,435 | $7,500 | $152,935 | $1,964,726 | $5,020,631 | $530,575 | $4,490,056 |
| 38 | $3,269,818 | $171,665 | $7,500 | $164,165 | $2,128,892 | $5,398,710 | $541,186 | $4,857,524 |
| 39 | $3,498,705 | $183,682 | $7,500 | $176,182 | $2,305,074 | $5,803,779 | $552,010 | $5,251,769 |
| 40 | $3,743,614 | $196,540 | $7,500 | $189,040 | $2,494,114 | $6,237,728 | $563,050 | $5,674,678 |
| 41 | $4,005,667 | $210,298 | $7,500 | $202,798 | $2,696,911 | $6,702,579 | $574,311 | $6,128,268 |
| 42 | $4,286,064 | $225,018 | $7,500 | $217,518 | $2,914,430 | $7,200,494 | $585,797 | $6,614,696 |
| 43 | $4,586,089 | $240,770 | $7,500 | $233,270 | $3,147,699 | $7,733,788 | $597,513 | $7,136,275 |
| 44 | $4,907,115 | $257,624 | $7,500 | $250,124 | $3,397,823 | $8,304,938 | $609,464 | $7,695,474 |
| 45 | $5,250,613 | $275,657 | $7,500 | $268,157 | $3,665,980 | $8,916,593 | $621,653 | $8,294,940 |
| 46 | $5,618,156 | $294,953 | $7,500 | $287,453 | $3,953,433 | $9,571,589 | $634,086 | $8,937,503 |
| 47 | $6,011,427 | $315,600 | $7,500 | $308,100 | $4,261,533 | $10,272,960 | $646,768 | $9,626,192 |
| 48 | $6,432,227 | $337,692 | $7,500 | $330,192 | $4,591,725 | $11,023,952 | $659,703 | $10,364,249 |
| 49 | $6,882,482 | $361,330 | $7,500 | $353,830 | $4,945,555 | $11,828,038 | $672,897 | $11,155,141 |
| 50 | $7,364,256 | $386,623 | $7,500 | $379,123 | $5,324,679 | $12,688,935 | $686,355 | $12,002,580 |
| 51 | $7,879,754 | $413,687 | $7,500 | $406,187 | $5,730,866 | $13,610,620 | $700,082 | $12,910,538 |
| 52 | $8,431,337 | $442,645 | $7,500 | $435,145 | $6,166,011 | $14,597,348 | $714,084 | $13,883,264 |
| 53 | $9,021,531 | $473,630 | $7,500 | $466,130 | $6,632,141 | $15,653,672 | $728,365 | $14,925,307 |
| 54 | $9,653,038 | $506,784 | $7,500 | $499,284 | $7,131,426 | $16,784,464 | $742,933 | $16,041,531 |
| 55 | $10,328,750 | $542,259 | $7,500 | $534,759 | $7,666,185 | $17,994,936 | $757,791 | $17,237,144 |
| 56 | $11,051,763 | $580,218 | $7,500 | $572,718 | $8,238,903 | $19,290,666 | $772,947 | $18,517,719 |
| 57 | $11,825,386 | $620,833 | $7,500 | $613,333 | $8,852,236 | $20,677,622 | $788,406 | $19,889,216 |
| 58 | $12,653,163 | $664,291 | $7,500 | $656,791 | $9,509,027 | $22,162,190 | $804,174 | $21,358,016 |
| 59 | $13,538,885 | $710,791 | $7,500 | $703,291 | $10,212,318 | $23,751,203 | $820,258 | $22,930,945 |
| 60 | $14,486,607 | $760,547 | $7,500 | $753,047 | $10,965,365 | $25,451,972 | $836,663 | $24,615,309 |
| 61 | $15,500,669 | $813,785 | $7,500 | $806,285 | $11,771,650 | $27,272,319 | $853,396 | $26,418,923 |
| 62 | $16,585,716 | $870,750 | $7,500 | $863,250 | $12,634,900 | $29,220,616 | $870,464 | $28,350,152 |
| 63 | $17,746,716 | $931,703 | $7,500 | $924,203 | $13,559,103 | $31,305,819 | $887,873 | $30,417,946 |
| 64 | $18,988,986 | $996,922 | $7,500 | $989,422 | $14,548,525 | $33,537,511 | $905,631 | $32,631,880 |
| 65 | $20,318,215 | $1,066,706 | $7,500 | $1,059,206 | $15,607,731 | $35,925,946 | $923,743 | $35,002,203 |
| 66 | $21,740,490 | $1,141,376 | $7,500 | $1,133,876 | $16,741,607 | $38,482,097 | $942,218 | $37,539,879 |
| 67 | $23,262,325 | $1,221,272 | $7,500 | $1,213,772 | $17,955,379 | $41,217,703 | $961,063 | $40,256,641 |
| 68 | $24,890,687 | $1,306,761 | $7,500 | $1,299,261 | $19,254,640 | $44,145,327 | $980,284 | $43,165,043 |
| 69 | $26,633,036 | $1,398,234 | $7,500 | $1,390,734 | $20,645,374 | $47,278,410 | $999,890 | $46,278,520 |
| 70 | $28,497,348 | $1,496,111 | $7,500 | $1,488,611 | $22,133,985 | $50,631,333 | $1,019,887 | $49,611,446 |
| 71 | $30,492,162 | $1,600,839 | $7,500 | $1,593,339 | $23,727,323 | $54,219,486 | $1,040,285 | $53,179,201 |
| 72 | $32,626,614 | $1,712,897 | $7,500 | $1,705,397 | $25,432,721 | $58,059,334 | $1,061,091 | $56,998,244 |
| 73 | $34,910,477 | $1,832,800 | $7,500 | $1,825,300 | $27,258,021 | $62,168,497 | $1,082,313 | $61,086,185 |
| 74 | $37,354,210 | $1,961,096 | $7,500 | $1,953,596 | $29,211,617 | $66,565,827 | $1,103,959 | $65,461,868 |
| 75 | $39,969,005 | $2,098,373 | $7,500 | $2,090,873 | $31,302,489 | $71,271,494 | $1,126,038 | $70,145,456 |
| 76 | | | | | | | | |

TABLE 3
Confidential
Compound Value of Land and Income 2
Land Value

| | |
|---|---|
| Initial Land Value | $100,000 |
| Average Growth | 7.00% |
| Value at start of period | 1 |

Lease

| | |
|---|---|
| Term | 199 |
| Rate | 5.25% |
| Honeymoon Period | 5 |

Funding
Type Inflation Linked Bonds

| | | |
|---|---|---|
| Coupon | 3.00% | Annual Arrears |
| Par Plus | 50.00% | of Inflation |
| Inflation | 4.00% | Estimate |
| Term | 50 | |
| | 5.00% | Est Cost Funds |

| | |
|---|---|
| Cash Rate | 3.50% |

| | | | | | Cash | | | |
|---|---|---|---|---|---|---|---|---|
| | | | | | Compound | | Bond Obligations | |
| | | | | Residual | Residual | Total | Debt Obligation | Vault |
| Year | Value | Income | Coupon | Income | Income | Assets | Inflation Linked | Surplus |
| 0 | $100,000 | $5,250 | $0 | $5,250 | $5,250 | $105,250 | $104,200 | $1,050 |
| 10 | $196,715 | $10,328 | $0 | $10,328 | $76,809 | $273,524 | $157,233 | $116,291 |
| 20 | $386,968 | $20,316 | $0 | $20,316 | $229,487 | $616,456 | $237,259 | $379,197 |
| 30 | $761,226 | $39,964 | $0 | $39,964 | $529,829 | $1,291,054 | $358,013 | $933,041 |
| 40 | $1,497,446 | $78,616 | $0 | $78,616 | $1,120,645 | $2,618,091 | $540,227 | $2,077,864 |
| 50 | $2,945,703 | $154,649 | $0 | $154,649 | $2,282,871 | $5,228,574 | $815,180 | $4,413,394 |
| 60 | $5,794,643 | $304,219 | $0 | $304,219 | $4,569,146 | $10,363,789 | $1,230,073 | $9,133,716 |
| 70 | $11,398,939 | $598,444 | $0 | $598,444 | $9,066,594 | $20,465,533 | $1,856,129 | $18,609,405 |
| 75 | $15,987,602 | $839,349 | $0 | $839,349 | $12,748,996 | $28,736,598 | $2,280,062 | $26,456,536 |

TABLE 4

| | | | | | Cash | | | |
|---|---|---|---|---|---|---|---|---|
| | | | | | Compound | | Bond Obligations | |
| | | | | Residual | Residual | Total | Debt Obligation | Vault |
| Year | Value | Income | Coupon | Income | Income | Assets | Inflation Linked | Surplus |
| 0 | $100,000 | $5,250 | $0 | $5,250 | $5,250 | $105,250 | $104,200 | $1,050 |
| 1 | $107,000 | $5,250 | $0 | $5,250 | $10,500 | $117,500 | $108,576 | $8,924 |
| 2 | $114,490 | $5,250 | $0 | $5,250 | $15,750 | $130,240 | $113,137 | $17,103 |
| 3 | $122,504 | $5,250 | $0 | $5,250 | $21,000 | $143,504 | $117,888 | $25,616 |
| 4 | $131,080 | $5,250 | $0 | $5,250 | $26,250 | $157,330 | $122,840 | $34,490 |
| 5 | $140,255 | $5,250 | $0 | $5,250 | $31,500 | $171,755 | $127,999 | $43,756 |
| 6 | $150,073 | $7,879 | $0 | $7,879 | $39,379 | $189,452 | $133,375 | $56,077 |
| 7 | $160,578 | $8,430 | $0 | $8,430 | $47,809 | $208,387 | $138,977 | $69,411 |
| 8 | $171,819 | $9,020 | $0 | $9,020 | $56,830 | $228,648 | $144,814 | $83,835 |
| 9 | $183,846 | $9,652 | $0 | $9,652 | $66,482 | $250,327 | $150,896 | $99,432 |
| 10 | $196,715 | $10,328 | $0 | $10,328 | $76,809 | $273,524 | $157,233 | $116,291 |
| 11 | $210,485 | $11,050 | $0 | $11,050 | $87,860 | $298,345 | $163,837 | $134,508 |
| 12 | $225,219 | $11,824 | $0 | $11,824 | $99,684 | $324,903 | $170,718 | $154,184 |
| 13 | $240,985 | $12,652 | $0 | $12,652 | $112,335 | $353,320 | $177,889 | $175,431 |
| 14 | $257,853 | $13,537 | $0 | $13,537 | $125,873 | $383,726 | $185,360 | $198,366 |
| 15 | $275,903 | $14,485 | $0 | $14,485 | $140,358 | $416,261 | $193,145 | $223,116 |
| 16 | $295,216 | $15,499 | $0 | $15,499 | $155,856 | $451,073 | $201,257 | $249,816 |
| 17 | $315,882 | $16,584 | $0 | $16,584 | $172,440 | $468,322 | $209,710 | $278,612 |
| 18 | $337,993 | $17,745 | $0 | $17,745 | $190,165 | $528,178 | $218,518 | $309,660 |
| 19 | $361,653 | $18,987 | $0 | $18,987 | $209,172 | $570,824 | $227,695 | $343,129 |
| 20 | $386,968 | $20,316 | $0 | $20,316 | $229,487 | $616,456 | $237,259 | $379,197 |
| 21 | $414,056 | $21,738 | $0 | $21,738 | $251,225 | $665,282 | $247,224 | $418,058 |
| 22 | $443,040 | $23,260 | $0 | $23,260 | $274,485 | $717,525 | $257,607 | $459,918 |
| 23 | $474,053 | $24,888 | $0 | $24,888 | $299,373 | $773,426 | $268,426 | $504,999 |
| 24 | $507,237 | $26,630 | $0 | $26,630 | $326,003 | $833,239 | $279,700 | $553,539 |
| 25 | $542,743 | $28,494 | $0 | $28,494 | $354,497 | $897,240 | $291,448 | $605,792 |
| 26 | $580,735 | $30,489 | $0 | $30,489 | $384,985 | $965,721 | $303,689 | $662,032 |
| 27 | $621,387 | $32,623 | $0 | $32,623 | $417,608 | $1,038,995 | $316,443 | $722,551 |
| 28 | $664,884 | $34,906 | $0 | $34,906 | $452,515 | $1,117,398 | $329,734 | $787,664 |
| 29 | $711,426 | $37,350 | $0 | $37,350 | $489,864 | $1,201,290 | $343,583 | $857,707 |
| 30 | $761,226 | $39,964 | $0 | $39,964 | $529,829 | $1,291,054 | $358,013 | $933,041 |
| 31 | $814,511 | $42,762 | $0 | $42,762 | $572,591 | $1,387,102 | $373,050 | $1,014,052 |
| 32 | $871,527 | $45,755 | $0 | $45,755 | $618,346 | $1,489,873 | $388,718 | $1,101,155 |
| 33 | $932,534 | $48,958 | $0 | $48,958 | $667,304 | $1,599,838 | $405,044 | $1,194,793 |
| 34 | $997,811 | $52,385 | $0 | $52,385 | $719,689 | $1,717,500 | $422,056 | $1,295,444 |
| 35 | $1,067,658 | $56,052 | $0 | $56,052 | $775,741 | $1,843,399 | $439,782 | $1,403,617 |
| 36 | $1,142,394 | $59,976 | $0 | $59,976 | $835,717 | $1,978,111 | $458,253 | $1,519,858 |
| 37 | $1,222,362 | $64,174 | $0 | $64,174 | $899,891 | $2,122,252 | $477,500 | $1,644,752 |
| 38 | $1,307,927 | $68,666 | $0 | $68,666 | $968,557 | $2,276,484 | $497,555 | $1,778,929 |
| 39 | $1,399,482 | $73,473 | $0 | $73,473 | $1,042,030 | $2,441,512 | $518,452 | $1,923,059 |
| 40 | $1,497,446 | $78,616 | $0 | $78,616 | $1,120,645 | $2,618,091 | $540,227 | $2,077,864 |
| 41 | $1,602,267 | $84,119 | $0 | $84,119 | $1,204,764 | $2,807,031 | $562,917 | $2,244,115 |
| 42 | $1,714,426 | $90,007 | $0 | $90,007 | $1,294,772 | $3,009,198 | $586,559 | $2,422,638 |
| 43 | $1,834,435 | $96,308 | $0 | $96,308 | $1,391,080 | $3,225,515 | $611,195 | $2,614,320 |
| 44 | $1,962,846 | $103,049 | $0 | $103,049 | $1,494,129 | $3,456,975 | $636,865 | $2,820,110 |
| 45 | $2,100,245 | $110,263 | $0 | $110,263 | $1,604,392 | $3,704,637 | $663,613 | $3,041,024 |
| 46 | $2,247,262 | $117,981 | $0 | $117,981 | $1,722,373 | $3,969,636 | $691,485 | $3,278,151 |
| 47 | $2,404,571 | $126,240 | $0 | $126,240 | $1,848,613 | $4,253,184 | $720,527 | $3,532,656 |
| 48 | $2,572,891 | $135,077 | $0 | $135,077 | $1,983,690 | $4,556,581 | $750,790 | $3,805,791 |
| 49 | $2,752,993 | $144,532 | $0 | $144,532 | $2,128,222 | $4,881,215 | $782,323 | $4,098,892 |
| 50 | $2,945,703 | $154,649 | $0 | $154,649 | $2,282,871 | $5,228,574 | $815,180 | $4,413,394 |
| 51 | $3,151,902 | $165,475 | $0 | $165,475 | $2,448,346 | $5,600,248 | $849,418 | $4,750,830 |
| 52 | $3,372,535 | $177,058 | $0 | $177,058 | $2,625,404 | $5,997,939 | $885,093 | $5,112,846 |
| 53 | $3,608,612 | $189,452 | $0 | $189,452 | $2,814,857 | $6,423,469 | $922,267 | $5,501,201 |
| 54 | $3,861,215 | $202,714 | $0 | $202,714 | $3,017,570 | $6,878,785 | $961,003 | $5,917,783 |
| 55 | $4,131,500 | $216,904 | $0 | $216,904 | $3,234,474 | $7,365,974 | $1,001,365 | $6,364,610 |
| 56 | $4,420,705 | $232,087 | $0 | $232,087 | $3,466,561 | $7,887,266 | $1,043,422 | $6,843,844 |
| 57 | $4,730,155 | $248,333 | $0 | $248,333 | $3,714,894 | $8,445,049 | $1,087,246 | $7,357,803 |
| 58 | $5,061,265 | $265,716 | $0 | $265,716 | $3,980,611 | $9,041,876 | $1,132,910 | $7,908,966 |
| 59 | $5,415,554 | $284,317 | $0 | $284,317 | $4,264,927 | $9,680,481 | $1,180,492 | $8,499,989 |
| 60 | $5,794,643 | $304,219 | $0 | $304,219 | $4,569,146 | $10,363,789 | $1,230,073 | $9,133,716 |
| 61 | $6,200,268 | $325,514 | $0 | $325,514 | $4,894,660 | $11,094,928 | $1,281,736 | $9,813,192 |
| 62 | $6,634,286 | $348,300 | $0 | $348,300 | $5,242,960 | $11,877,246 | $1,335,569 | $10,541,678 |
| 63 | $7,098,686 | $372,681 | $0 | $372,681 | $5,615,641 | $12,714,328 | $1,391,663 | $11,322,665 |
| 64 | $7,595,595 | $398,769 | $0 | $398,769 | $6,014,410 | $13,610,004 | $1,450,113 | $12,159,892 |
| 65 | $8,127,286 | $426,683 | $0 | $426,683 | $6,441,092 | $14,568,378 | $1,511,017 | $13,057,361 |
| 66 | $8,696,196 | $456,550 | $0 | $456,550 | $6,897,643 | $15,593,839 | $1,574,480 | $14,019,359 |
| 67 | $9,304,930 | $488,509 | $0 | $488,509 | $7,386,151 | $16,691,081 | $1,640,608 | $15,050,473 |
| 68 | $9,956,275 | $522,704 | $0 | $522,704 | $7,908,856 | $17,865,131 | $1,709,514 | $16,155,617 |
| 69 | $10,653,214 | $559,294 | $0 | $559,294 | $8,468,150 | $19,121,364 | $1,781,313 | $17,340,050 |
| 70 | $11,398,939 | $598,444 | $0 | $598,444 | $9,066,594 | $20,465,533 | $1,856,129 | $18,609,405 |
| 71 | $12,196,865 | $640,335 | $0 | $640,335 | $9,706,929 | $21,903,794 | $1,934,086 | $19,969,708 |
| 72 | $13,050,646 | $685,159 | $0 | $685,159 | $10,392,088 | $23,442,734 | $2,015,318 | $21,427,416 |
| 73 | $13,964,191 | $733,120 | $0 | $733,120 | $11,125,208 | $25,089,399 | $2,099,961 | $22,989,438 |
| 74 | $14,941,684 | $784,438 | $0 | $784,438 | $11,909,647 | $26,851,331 | $2,188,159 | $24,663,171 |
| 75 | $15,987,602 | $839,349 | $0 | $839,349 | $12,748,996 | $28,736,598 | $2,280,062 | $26,456,536 |
| 76 | | | | | | | | |

Confidential
Example Calculation Valuation and Rental:

| Rental Margin | 15.00% | | | | | |
|---|---|---|---|---|---|---|
| Initial Acquisition Price | $250,000 | | | | | |
| Adjusted Rental Fee | 4.41% | 5.43% | 6.47% | 6.47% | 6.47% | 6.47% |
| Years | 1 | 2 | 10 | 25 | 50 | 75 |
| Opening Value | $250,000 | $259,588 | $402,261 | $914,489 | $3,593,460 | $14,116,372 |
| Valuation Factor | 3.84% | 4.73% | 5.63% | 5.63% | 5.63% | 5.63% |
| Estimated Annual Income | $11,026 | $14,105 | $21,858 | $59,156 | $232,452 | $913,153 |
| Estimated Total Income | $11,026 | $25,132 | $199,994 | $1,087,335 | $6,898,632 | $29,727,453 |

Calcualtion of Factor
Indicies

| | | | | | | |
|---|---|---|---|---|---|---|
| Index 1 - Residex | 1.00% | 1.00% | | | | |
| Index 2 - Reserve Bank | 2.00% | 2.00% | 5.00% | 5.00% | 5.00% | 5.00% |
| Index 3 - 50 Yr Average | 7.00% | 7.00% | 7.00% | 7.00% | 7.00% | 7.00% |
| CPI - Reserve Bank | 4.00% | 4.00% | 4.00% | 4.00% | 4.00% | 4.00% |
| Bond Rates - Markets | 3.25% | 3.25% | 3.25% | 3.25% | 3.25% | 3.25% |

Weighting of Indices

| | | | | | | |
|---|---|---|---|---|---|---|
| Index 1 - residex | 20.00% | 0.00% | 0.00% | 0.00% | 0.00% | 0.00% |
| Index 2 - Reserve Bank | 20.00% | 20.00% | 0.00% | 0.00% | 0.00% | 0.00% |
| Index 3 - 50 Yr Average | 40.00% | 60.00% | 80.00% | 80.00% | 80.00% | 80.00% |
| CPI - Reserve Bank | 4.00% | 0.00% | 0.00% | 0.00% | 0.00% | 0.00% |
| Bond Rates - Markets | 16.00% | 20.00% | 20.00% | 20.00% | 20.00% | 20.00% |
| | 100.00% | 100.00% | 100.00% | 100.00% | 100.00% | 100.00% |

Weighted Indicies

| | | | | | | |
|---|---|---|---|---|---|---|
| Index 1 - residex | 0.20% | 0.00% | 0.00% | 0.00% | 0.00% | 0.00% |
| Index 2 - Reserve Bank | 0.40% | 0.40% | 0.00% | 0.00% | 0.00% | 0.00% |
| Index 3 - 50 Yr Average | 2.80% | 4.20% | 5.60% | 5.60% | 5.60% | 5.60% |
| CPI - Reserve Bank | 0.16% | 0.00% | 0.00% | 0.00% | 0.00% | 0.00% |
| Bond Rates - Markets | 0.52% | 0.65% | 0.65% | 0.65% | 0.65% | 0.65% |
| Weighted Index | 4.08% | 5.25% | 6.25% | 6.25% | 6.25% | 6.25% |

Weighting of Influences

| | | | | | | |
|---|---|---|---|---|---|---|
| International Political Issues | 60.00% | 40.00% | 40.00% | 40.00% | 40.00% | 40.00% |
| National Political Issues | 110.00% | 110.00% | 110.00% | 110.00% | 110.00% | 110.00% |
| State Political Issues | 110.00% | 110.00% | 110.00% | 110.00% | 110.00% | 110.00% |
| Regional Issues | 90.00% | 90.00% | 90.00% | 90.00% | 90.00% | 90.00% |
| Local Issues | 100.00% | 100.00% | 100.00% | 100.00% | 100.00% | 100.00% |
| Average Weighted Influences | 94.00% | 90.00% | 90.00% | 90.00% | 90.00% | 90.00% |
| Valuation Factor | 3.84% | 4.73% | 5.63% | 5.63% | 5.63% | 5.63% |

Capital Investment Only

| | | | | | 4% |
|---|---|---|---|---|---|
| | | | | | Notional |
| | | | 2006 | Monthly | Future |
| PBU Name | Maturity | Years | Investment | Contribution | Value |
| LOLA-2025 | 2025 | 19 | $1,000 | $0 | $2,222.58 |
| LOLA-2026 | 2026 | 20 | $1,000 | $0 | $2,313.13 |
| LOLA-2027 | 2027 | 21 | $1,000 | $0 | $2,407.37 |
| LOLA-2028 | 2028 | 22 | $1,000 | $0 | $2,505.45 |
| LOLA-2029 | 2029 | 23 | $1,000 | $0 | $2,607.53 |
| LOLA-2030 | 2030 | 24 | $1,000 | $0 | $2,713.77 |
| LOLA-2031 | 2031 | 25 | $1,000 | $0 | $2,824.33 |
| LOLA-2032 | 2032 | 26 | $1,000 | $0 | $2,939.40 |
| LOLA-2033 | 2033 | 27 | $1,000 | $0 | $3,059.15 |
| LOLA-2034 | 2034 | 28 | $1,000 | $0 | $3,183.79 |
| LOLA-2035 | 2035 | 29 | $1,000 | $0 | $3,313.50 |
| LOLA-2036 | 2036 | 30 | $1,000 | $0 | $3,448.50 |
| LOLA-2037 | 2037 | 31 | $1,000 | $0 | $3,588.99 |
| LOLA-2038 | 2038 | 32 | $1,000 | $0 | $3,735.21 |
| LOLA-2039 | 2039 | 33 | $1,000 | $0 | $3,887.39 |
| LOLA-2040 | 2040 | 34 | $1,000 | $0 | $4,045.77 |
| LOLA-2041 | 2041 | 35 | $1,000 | $0 | $4,210.60 |
| LOLA-2042 | 2042 | 36 | $1,000 | $0 | $4,382.15 |
| LOLA-2043 | 2043 | 37 | $1,000 | $0 | $4,560.68 |
| LOLA-2044 | 2044 | 38 | $1,000 | $0 | $4,746.49 |
| LOLA-2045 | 2045 | 39 | $1,000 | $0 | $4,939.87 |
| LOLA-2046 | 2046 | 40 | $1,000 | $0 | $5,141.13 |
| LOLA-2047 | 2047 | 41 | $1,000 | $0 | $5,350.59 |

APPENDIX E
Wages Growth

| | | Capital Investment + Monthly Contributions | | |
|---|---|---|---|---|
| | | | | 4% Notional |
| | | 2006 | 3% Monthly | Future |
| PBU Name | Maturity | Investment | Contribution | Value |
| LOLA-2025 | 2025 | $700 | $1.00 | $1,922.58 |
| LOLA-2026 | 2026 | $700 | $1.03 | $2,024.95 |
| LOLA-2027 | 2027 | $700 | $1.06 | $2,133.09 |
| LOLA-2028 | 2028 | $700 | $1.09 | $2,247.33 |
| LOLA-2029 | 2029 | $700 | $1.13 | $2,368.06 |
| LOLA-2030 | 2030 | $700 | $1.16 | $2,495.65 |
| LOLA-2031 | 2031 | $700 | $1.19 | $2,630.53 |
| LOLA-2032 | 2032 | $700 | $1.23 | $2,773.14 |
| LOLA-2033 | 2033 | $700 | $1.27 | $2,923.95 |
| LOLA-2034 | 2034 | $700 | $1.30 | $3,083.45 |
| LOLA-2035 | 2035 | $700 | $1.34 | $3,252.19 |
| LOLA-2036 | 2036 | $700 | $1.38 | $3,430.73 |
| LOLA-2037 | 2037 | $700 | $1.43 | $3,619.68 |
| LOLA-2038 | 2038 | $700 | $1.47 | $3,819.67 |
| LOLA-2039 | 2039 | $700 | $1.51 | $4,031.41 |
| LOLA-2040 | 2040 | $700 | $1.56 | $4,255.60 |
| LOLA-2041 | 2041 | $700 | $1.60 | $4,493.04 |
| LOLA-2042 | 2042 | $700 | $1.65 | $4,744.56 |
| LOLA-2043 | 2043 | $700 | $1.70 | $5,011.02 |
| LOLA-2044 | 2044 | $700 | $1.75 | $5,293.39 |
| LOLA-2045 | 2045 | $700 | $1.81 | $5,592.66 |
| LOLA-2046 | 2046 | $700 | $1.86 | $5,909.91 |
| LOLA-2047 | 2047 | $700 | $1.92 | $6,246.26 |

1. A method of determining the value of a property, using a processing system, said property including land owned by a first party, said method comprising the steps of:
determining a first value representing value of the property at a first time;
determining a second value representing value of the property at a second time excluding modifications made to the land by a second party to whom said property is being leased during a period between said first time and said second time; and
outputting the second value for the property, wherein said first party retains ownership of the land and is entitled to an amount based on the output second value, and wherein said second party retains ownership of said modifications made to the land during said period and is entitled to an amount based on the value of said modifications made to the land during said period.

2-20. (canceled)

21. A processing system for determining the value of a property, said property including land owned by a first party, said system comprising:
a storage means for storing data;
at least one processing means connected to said storage means, said processing means being configured for determining a first value representing value of the property at a first time, for determining a second value representing value of the property at a second time; for excluding modifications made to the land by a second party to whom said property is being leased during a period between said first time and said second time; and for outputting the second value, wherein said first party retains ownership of the land and is entitled to an amount based on the output second value, and wherein said second party retains ownership of said modifications made to the land during said period and is entitled to an amount based on the value of said modifications made to the land during said period.

22-30. (canceled)

31. A computer readable storage medium, having a program recorded thereon, where the program is configured to make a computer execute a procedure to determine the value of a property, said property including land owned by a first party, said program comprising:
code for determining a first value representing value of the property at a first time;
code for determining a second value representing value of the property at a second time
code for excluding modifications made to the land by a second party to whom said property is being leased during a period between said first time and said second time; and
code for outputting the second value, wherein said first party retains ownership of the land and is entitled to an amount based on the output second value, and wherein said second party retains ownership of said modifications made to the land during said period and is entitled to an amount based on the value of said modifications made to the land during said period.

32. An apparatus for determining the value of a property said property including land owned by a first party, said apparatus comprising:
storage means for storing data;
at least one processor connected to said storage means, said processor being configured for determining a first value representing value of the property at a first time, for determining a second value representing value of the property at a second time excluding modifications made to the land by a second party to whom said property is being leased during a period between said first time and said second time, and for outputting the second value for the property, wherein said first party retains ownership of the land and is entitled to an amount based on the output second value, and wherein said second party retains ownership of said modifications made to the land during said period and is entitled to an amount based on the value of said modifications made to the land during said period.

33. A method of determining the value of a property, using a processing system, said property including land owned by a first party, said method comprising:
storing a record corresponding to a second party to whom the property is being leased, said record including at least a first value representing value of the property at a first time;
determining a second value representing value of the property at a second time excluding modifications made to the land by said second party in a period between said first time and said second time;
updating the record corresponding to the second party according to the second value; and
outputting the second value for the property, wherein the first party retains ownership of the land and is entitled to an amount based on the output second value and said second party retains ownership of the modifications made to the land during said period and is entitled to an amount based on a value of said modifications made to the land during said period.

34. A processing system for determining the value of a property, said property including land owned by a first party, said system comprising:
storage means for storing a record corresponding to a second party to whom the property is being leased, said record including at least a first value representing value of the property at a first time;
at least one processing means connected to said storage means, said processing means being configured for determining a second value representing value of the property at a second time excluding modifications made to the land by said second party in a period between said first time and said second time, for updating the record corresponding to the second party according to the second value; and
for outputting the second value, wherein the first party retains ownership of the land and is entitled to an amount based on the output second value and said second party retains ownership of the modifications made to the land during said period and is entitled to an amount based on a value of said modifications made to the land during said period.

35. A computer readable storage medium, having a program recorded thereon, where the program is configured to make a computer execute a procedure to a method of determining the value of a property, said property including land owned by a first party, said method comprising:
code for storing a record corresponding to a second party to whom the property is being leased, said record including at least a first value representing value of the property at a first time;
code for determining a second value representing value of the property at a second time excluding modifications made to the land by said second party in a period between said first time and said second time;
code for updating the record corresponding to the second party according to the second value; and
code for outputting the second value, wherein the first party retains ownership of the land and is entitled to an amount based on the output second value and said second party retains ownership of the modifications made to the land during said period and is entitled to an amount based on a value of said modifications made to the land during said period.

36. An apparatus for determining the value of a property, using a processing system, said property including land owned by a first party, said method comprising:
storage means for storing a record corresponding to a second party to whom the property is being leased, said record including at least a first value representing value of the property at a first time;
at least one processor connected to said storage means, said processor being configured for determining a second value representing value of the property at a second time excluding modifications made to the land by said second party in a period between said first time and said second time, for updating the record corresponding to the second party according to the second value, and for outputting the second value for the property, wherein the first party retains ownership of the land and is entitled to an amount based on the output second value and said second party retains ownership of the modifications made to the land during said period and is entitled to an amount based on a value of said modifications made to the land during said period.

37. A method of determining land value using a processing system, wherein land owned by a first party is provided to a second party under an agreement allowing the second party to access and use the land as if the second party owned the land, and allowing the second party to have one or more modifications made to the land, said method comprising the steps of:
determining a value of the land excluding any modifications made to the land; and
outputting the value of the land, wherein under the agreement the first party retains ownership of the land and is entitled to the value of the land and the second party retains ownership of the modifications and is entitled to at least a portion of a value of the modifications.

38-58. (canceled)

59. A method of buying land to which one or more modifications have been made, using a processing system, said method comprising the steps of:
determining a value of the land excluding the modifications made to the land;
outputting said value and giving consideration commensurate with said value to the owner of the land in exchange for the land, the seller retaining ownership of the modifications made to the land;
providing the land to the seller under an agreement allowing the seller to access and use the land as if the seller still owned the land, and allowing the seller to have one or more further modifications made to the land, wherein under the agreement the seller may trade or deal with one or more of the modifications made to the land and is entitled to at least a portion of a value of the modifications.

60-62. (canceled)

63. A method of determining land value, using a processing system, said method comprising the steps of:
determining a value of the land excluding any modifications made to the land;
outputting the value of the land and lending a buyer an amount commensurate to the value of the land to enable the buyer to purchase the land with the land being used as security for the loan;
providing the buyer, under an agreement, with the land to use and occupy and to have one or more further modifications made to the land,
wherein under the agreement the buyer retains ownership of the modifications made to the land, and is entitled to at least a portion of a value of the modifications on sale of the modifications.

64-77. (canceled)

78. A method of providing land usage and occupation rights, said method comprising the steps of:
leasing land owned by a first party to a second party under an agreement allowing the second party to access and use the land as if the second party owned the land; and
allowing the second party to have one or more modifications made to the land, wherein upon the modifications being made to the land the second party retains ownership of the modifications.

79. A method of buying land to which one or more modifications have been made, said method comprising the steps of:
giving consideration to the owner of the land in exchange for the land with the seller retaining ownership of the modifications made to the land;
providing the land to the seller under an agreement allowing the seller to access and use the land as if the seller still owned the land;
allowing the seller to have one or more further modifications made to the land, wherein the seller may trade or deal with one or more of the modifications and any further modifications.

80. An apparatus for determining land value, wherein land owned by a first party is provided to a second party under an agreement allowing the second party to access and use the land as if the second party owned the land, and the second party is allowed to have one or more modifications made to the land, said apparatus comprising:
storage means for storing data;
at least one processing means connected to said storage means, said processing means being configured for determining a value of the land excluding any modifications made to the land, and for outputting the value of the land, wherein under the agreement the first party retains ownership of the land and is entitled to the value of the land and the second party retains ownership of the modifications and is entitled to at least a portion of a value of the modifications.

81. A computer readable storage medium, having a program recorded thereon, where the program is configured to make a computer execute a procedure to determining land value, wherein land owned by a first party is provided to a second party under an agreement allowing the second party to access and use the land as if the second party owned the land, and allowing the second party to have one or more modifications made to the land, said program comprising:
code for determining a value of the land excluding any modifications made to the land; and
code for outputting the value of the land, wherein under the agreement the first party retains ownership of the land and is entitled to the value of the land and the second party retains ownership of the modifications and is entitled to at least a portion of a value of the modifications.

83. A method of determining a redemption value of a financial instrument having a predetermined maturity date, using at least one processing system, said method comprising the steps of:
determining a first value representing value of the property at a first time;
determining a second value representing value of the property at the predetermined maturity date, excluding modifications made to the land by a second party to whom said property is being leased during a period between said first time and said maturity date;
determining the redemption value of the financial instrument based on the second value; and
outputting the redemption value of the financial instrument, wherein said first party retains ownership of the land and is entitled to an amount based on the second value, and wherein said second party retains ownership of said modifications made to the land during said period and is entitled to an amount based on the value of said modifications made to the land during said period.

84-101. (canceled)

102. An apparatus for determining a redemption value of a financial instrument having a predetermined maturity date, using at least one processing system, said apparatus comprising:
storage means for storing data
at least one processor connected to the storage means, the processor being configured for determining a first value representing value of the property at a first time, for determining a second value representing value of the property at the predetermined maturity date, excluding modifications made to the land by a second party to whom said property is being leased during a period between said first time and said maturity date, for determining the redemption value of the financial instrument based on the second value, and for outputting the redemption value of the financial instrument, wherein said first party retains ownership of the land and is entitled to an amount based on the second value, and wherein said second party retains ownership of said modifications made to the land during said period and is entitled to an amount based on the value of said modifications made to the land during said period.

103. A computer readable storage medium, having a program recorded thereon, where the program is configured to make a computer execute a procedure to determine a redemption value of a financial instrument having a predetermined maturity date, using at least one processing system, said program comprising:
code for determining a first value representing value of the property at a first time;
code for determining a second value representing value of the property at the predetermined maturity date, excluding modifications made to the land by a second party to whom said property is being leased during a period between said first time and said maturity date;
code for determining the redemption value of the financial instrument based on the second value; and
code for outputting the redemption value of the financial instrument, wherein said first party retains ownership of the land and is entitled to an amount based on the second value, and wherein said second party retains ownership of said modifications made to the land during said period and is entitled to an amount based on the value of said modifications made to the land during said period.

104. A processing system for determining a redemption value of a financial instrument having a predetermined maturity date, said system comprising:
storage means for storing data;
at least one processor connected to said storage means, said processor being configured for determining a first value representing value of the property at a first time, for determining a second value representing value of the property at the predetermined maturity date, excluding modifications made to the land by a second party to whom said property is being leased during a period between said first time and said maturity date, for determining the redemption value of the financial instrument based on the second value, and for outputting the redemption value of the financial instrument, wherein said first party retains ownership of the land and is entitled to an amount based on the second value, and wherein said second party retains ownership of said modifications made to the land during said period and is entitled to an amount based on the value of said modifications made to the land during said period.
